(19) United States
(12) Patent Application Publication
(10) Pub. No.: US 2003/0204503 A1
(43) Pub. Date: Oct. 30, 2003

(54) Connecting entities with general functionality in aspect patterns

(76) Inventors: Lars Hammer, Frederiksberg (DK); Morten Nielsen, Vedbaek (DK)

Correspondence Address: Joseph R. Kelly, WESTMAN CHAMPLIN & KELLY, International Centre - Suite 1600, 900 South Second Avenue, Minneapolis, MN, 55402-3319, US

(21) Appl. No.: 10/365,824

(22) Filed: Feb. 13, 2003

Related U.S. Application Data
(63) Continuation-in-part of application No. PCT/DK01/00740, filed on Nov. 9, 2001.
(60) Provisional application No. 60/355,808, filed on Feb. 13, 2002.

(30) Foreign Application Priority Data
Nov. 11, 2000 (DK) PA 200 01670

(51) Int. Cl. G06F 17/30

(52) U.S. Cl. 707/6

(57) ABSTRACT

A task oriented user interface increases ease of use of the system because the user is guided through the system. The tasks resemble how the user thinks he/she should do the job. This aids and assists the user in doing the job.

The present application is based on and claims the benefit of U.S. provisional patent application Serial No. 60/355,808, filed Feb. 13, 2002 and entitled TASK PATTERNS, the content of which is hereby incorporated by reference in its entirety.

### FIELD OF THE INVENTION

The present invention relates to a computer system for configuration of one or more tasks.

### BACKGROUND OF THE INVENTION

When programming extensive computer applications that are both highly complex as well as a highly flexible there is a wish to factor out common functionality. Functionality is commonly reused on a “cut and paste” basis and it is difficult to interface between the different constituent components because there is no clear encapsulation of functionality and separation of data and methods. This leads to inconsistencies and low quality, because a reused piece of functionality has no intelligence—it does not know where it came from, and does not synchronize automatically with its progenitor. Furthermore, maintenance is laborious, because the same functionality is repeated, maybe with slight variants, in many different places. Therefore, it takes time to identify all places where an update is required, and the process requires manual intervention and is therefore error-prone.

A way to overcome some of these problems is to use Object Oriented programming. In Object Oriented programming:

Reuse is somewhat controlled, as common functionality can be factored out into objects with well-defined interfaces.

Interoperability is facilitated, because objects have well-defined and well-described interfaces.

Variance can be controlled by use of inheritance. Inheritance makes sure that any change to the progenitor will be applied to its descendants.

The level of abstraction is supposedly heightened, as objects should ideally be rooted in the business problem domain, not in the “computer”, domain.

However, problems still exist. For instance, extending a solution can be a bottleneck because the programmer is responsible for the infrastructure, without which there is no application.

A more structured way of using Object Oriented programming can be provided in a “framework”. An advantage of a “framework” for application development is that the common functionality is provided in the framework, not in libraries or utility classes. The framework, basically, becomes a framework by providing common functionality plus setting the infrastructure of a working program. However this kind of programming is also based on inheritance and, therefore, cannot be easily upgraded.

Within the last couple of years several attempts to create a frame-based programming language that organizes the programming code for the programmer have been suggested. The overall idea promulgated by introducing this programming technique is that all Objects are based on predefined pieces of code. Among others, such systems are set out in “Subject-Oriented Programming” by IBM and “Aspect-Oriented Programming” by Xerox PARC Software.

Even though this way of programming helps the programmer organize the objects, the programmer is still responsible for describing how these pieces of functionality interact by writing code from scratch, and writing how these pieces of functionality are combined. This process is also known as “weaving”.

It is a disadvantage of these framework-based programming languages that basically all the weaving has to be redone, or at least checked, every time the pieces of functionality change. This makes upgrading the framework complicated and expensive.

Furthermore, some functionality of an object will be provided in the weaving code. Therefore, it is impossible for the framework to guarantee a system-wide quality of the application, because the framework has no way of knowing what the weaving code does.

### SUMMARY OF THE INVENTION

A task oriented user interface increases ease of use of the system because the user is guided through the system. The tasks resemble how the user thinks he/she should do the job. This aids and assists the user in doing the job.

In a webbased environment, pages have to be simple and task based because each piece of information has to be sent to a server. The server responds to these pieces of information with the next step and so on. Good web design can mean focusing on a single task per page and providing explicit (i.e. not just the forward and backward buttons) navigation forward and backward through pages. Similarly, inductive navigation starts with focusing the activity on each page to a single, primary task. The main principles of inductive navigation can be summed up with the following four steps:

1. Focus each page on a single task.

2. State or name the task.

3. Make the page's content suit the task. The task is stated on the page. It should be obvious how to carry out the task with the controls on the page.

4. Offer links to secondary tasks.

In a fashion similar to web design, the next task is generated and presented to the user in response to previous tasks. Each task sequence has to be programmed in advance in order to be able to present the right order of tasks for the user. This is done in the component that controls the user interface (UI). It is a disadvantage that all possible task sequences have to be programmed.

One feature of the present invention reduces the amount of code in the component that controls the UI in order to present the task sequences. This reduces the time spent on programming or configuring the UI and facilitating programming or configuring an application.

In a broad aspect of the invention a computer system is provided for configuring a task, said computer system comprising a design component for configuring the task, the design component having access to or being provided with:

a set of Business Object Types

a set of Task Patterns wherein at least one of said Task Patterns comprises:

at least one task step pattern comprising runtime functionality being able to interact on a Business Object Instance,

wherein the Design Component is adapted to establish connection between a Business Object Type and a task pattern.

In another broad aspect, a method is provided for configuring a task, said method comprising the steps of:

connecting one or more Task Patterns with a Business Object Type.

A method of automatic generation of a task sequence by use of a computer system is provided, which method comprising the steps of:

1. presenting by use of a computer system a first task preferably comprising information of a Business Object Type for a user of an application;

2. firing an Event Instance in response to an input to the computer;

3. identifying whether the first task can be completed by:

a. identifying whether an element of a Business Object Type is in a state where it can react to the Event Instance; and

b. if not, so identifying what needs to be completed in order to bring the element into a state where it can react to the Event Instance; and

4. in response to step 3b, presenting a task comprising information about what needs to be completed in order to bring the element into a state where it can react to the Event Instance.

It is an advantage of the method that the application developer does not have to configure/program all possible task sequences, thus facilitating the programming/configuration of an application. Also, in this way a more consistent generation of task sequences will be ensured. Furthermore, the risk that a program developer has not identified a task sequence (and thus that a task sequence will be missing) is reduced due to the automatic generation of the task sequence. A Business Object Type may comprise one or more elements. An element may be a Business Object Instance of the Business Object Type or it may comprise data, meta-data, functionality or information about the element, such as the state.

In an embodiment of the invention a method is provided wherein step 3 is repeated until there are no more elements of a Business Object Type that are in a state where they cannot react to the Event Instance.

In another embodiment of the method, the first task in step 1 comprises information such as meta-data, data, or information with respect to functionality of the Business Object Type.

Also within the scope of the invention is a method wherein the first task comprises information of an Event Type configured with the Business Object Type.

Another embodiment of the invention provides a method wherein step 1 further comprises presenting a complete or partially created Business Object Instance.

Also, within the scope of the invention is a method wherein step 2 further comprises a step of sending a first message from a UI component to a Business Object Controller (BOC). Illustratively a method is provided wherein the first message comprises identification and or state information of the Event Type and the Business Object Type, such as Business Object Instances thereof.

In further embodiments of the invention a method is provided wherein the element of the Business Object Type is an Aspect Instance. Illustratively a method is provided wherein step 3a comprises a step of sending a second message to an Aspect Pattern of the Aspect Instance. Also a method is provided wherein the second message comprises identification and/or state information of the Event Type. Preferably the second message is sent by a BOC.

Also within the scope of the invention is a method further comprising a step of returning a third message comprising information of whether the element is in a state where it is possible for the element to react to the Event Instance.

A method is also provided for automatic generation of a list of possible tasks to perform on a Business Object comprising one or more elements by use of a computer, the method comprising the steps of:

1. firing in response to an input to a computer one or more Event Instances related with the Business Object, each Event Instance being related with a task;

2. identifying whether each task can be completed by identifying whether the one or more elements of the Business Object is in a state where it can react to the Event Instance; and

3. if the task can be completed, presenting the task on a list comprising possible tasks to perform on the Business Object.

It is an advantage that a user of the system is provided with a list of possible tasks that currently can be performed due to the state of the one or more elements of the Business Object Type.

Further a method is provided, which method comprises providing an automatic generation of a task sequence by use of a computer system comprising processor means such as one or more central processing units programmed to perform actions in accordance with the generation of the task sequence, storage means such as RAM and a hard disc storing data used in the generation of the task sequence, said method comprising the steps of:

1. presenting by use of a computer system a first task:

2. querying in response to an input to the computer system whether the first task can be completed by use of the computer system, the querying comprising:

a. querying if an element of a Business Object Type is in a state where it can react to an Event Instance of a first Event Type; and

b. if not, so identifying by use of the computer system what needs to be completed in order to bring the element into a state where it can react to an Event Instance of the first Event Type.

The computer system may be realized, for instance, by a stand-alone computer or as a distributed computer system. Preferably the presenting of the first task is based on a selection of a task made by a user of the computer system.

In an embodiment of the invention, step 2b further, as a result of the identification of what needs to be completed, presents a task comprising information about what needs to be completed in order to bring the element in a state where it can react to an Event Instance of the first Event Type.

In another embodiment of the invention, a method is provided wherein the result of a query to an element is obtained by functionality available to the element, said functionality being triggered by querying the element. Preferably the functionality is within the element.

Also within the scope of the invention is a method wherein the step 2b of identifying is done by functionality available to the element in question thereby providing information on what needs to be done in order to bring the element in question into a state where it can react.

In further embodiments of the invention, a method wherein the input to the computer system is a user input. Also the input may be provided by a user via a keyboard, a voice control, a computer mouse or the like. The input may also stem from a connected computer system. Furthermore the input may arrive via the internet.

In another embodiment of the invention, a method is provided where step 2 is repeated for all elements of the Business Object Type.

Also within the scope of the invention a method is provided further comprising a step 3 of firing an Event Instance of the first Event Type as result of step 2a if the element of the Business Object Type is in a state where it can react to the Event Instance of the first Event Type.

In another embodiment of the invention a method is provided wherein as the result of step 2b the presented task is, recursively, assigned to be a first task and repeating step 1 and step 2 whereby the presented task becomes the first task. Preferably step 1 and step 2 is repeated one or more times. Also within the scope of the invention the repeating of step 1 and step 2 is repeated a limited number of times. Preferably the limited number of times is predefined such as the limited number of times being between 1 and 10. Also a method is provided wherein step 1 and step 2 are repeated until all tasks of the first task and all their subsidiary tasks have been successfully completed.

In other embodiments of the invention, a method is provided further comprising a step of canceling the method. Preferably the method is canceled due to an input to the computer system. The method may be canceled due to a user input such as an input via a keyboard, a computer mouse, a voice control or the like. The method may further be canceled via the Internet. Also the method may be canceled via a connected computer system.

Also within the scope of the invention a method is provided further comprising a step 2c wherein the task presented in step 2b is completed by firing an Event Instance of a second Event Type thereby changing the state of the element type to a state wherein the element type can react to the Event Instance of the first Event Type.

In another embodiment of the invention a method is provided wherein step 2 is repeated until all elements of the Business Object Type can react to an Event Instance of the first Event Type.

In a further embodiment a method is provided further comprising a step 3 wherein an Event Instance of the first Event Type is fired.

In another embodiment a method is provided wherein the first task in step 1 comprises information such as meta-data, data, or information with respect to functionality of the Business Object Type.

Also within the scope of the invention a method is provided wherein the first task comprises information of an Event Type configured with the Business Object Type. Preferably step 1 further comprises presenting a complete or partial Business Object Instance.

In further embodiments of the invention, a method is provided wherein step 2 further comprises a step of sending a first message from a User Interface (UI) component to a Business Object Controller (BOC). Preferably the first message comprises identification and/or state information of the Event Type and the Business Object Type, such as Business Object Instances hereof.

In an embodiment of the invention a method is provided wherein an element of the Business Object Type is an Aspect Instance.

It is also within the scope of the invention to provide a method wherein step 2a comprises a step of sending a second message to an Aspect Pattern of the Aspect Instance. Preferably the second message comprises identification of the Event Type. Also the second message is sent by a Business Object Controller (BOC).

In another embodiment of the invention a method is provided, wherein step 2a further comprises a step of returning a third message comprising information of whether the element is in a state where it is possible for the element to react to the Event Instance.

A computer system is provided, for running a method according to other aspects, said computer system comprising:

processor means such as one or more central processing units programmed to perform actions in accordance with the generation of the task sequence;

storage means such as RAM and a hard disc storing data used in the generation of the task sequence;

a BOC component generating the first task; and

a UI component rendering the task information to a device.

A system for configuring a Business Object Type is provided and may be useful with the invention, said system comprising a design component for configuring the Business Object Type, the design component having access to or being provided with; Business Object Type connecting means, a set of Aspect Patterns wherein at least one of said Aspect Patterns comprises: Aspect connecting means, one or more pieces of generalized functionality; wherein the pieces of generalized functionality are adapted to be specified, thereby providing pieces of specific functionality, and one or more Aspect Event Type connecting means enabling that one or more pieces of functionality can be triggered, a set of Event Types, wherein at least one of said Event Types comprises Event Type connecting means.

It is an advantage of the system that Business Object Types more easily can be created by configuring the predefined pieces of functionality in the one or more Aspect Patterns, configuring the Business Object Type with the one or more Aspect Patterns, configuring the one or more Event Types with the Business Object Types and configuring the Event Types with one or more pieces of functionality in the one or more Aspect Patterns thereby enabling one or more pieces of functionality to be triggered in the Aspect Patterns. It is a further advantage of the system that, before the configuration, there does not exist any connections between the Aspect Patterns and the Business Object Type, or the Event Types and the Business Object Type. Neither does any of the Aspect Patterns have any mutual connections before the configuration. This is an advantage since it facilitates upgrades of the system. Furthermore, the level of abstraction is higher compared to traditional configuration thus supporting faster modeling and higher quality of an application.

In the following, a number of technical terms are used. The use of these terms is believed not to be in contradiction with the ordinary use of the terms, but in order to ease the understanding of the invention, a short list of some terms are given below together with an indication of the meaning of these words:

Meta-data (synonyms: type data, 2nd order data): Data that is related to the type of data instead of to the data itself. For example a postal address may comprise the elements: street, number, zip, city and country. The information about which elements a postal address comprises is meta-data. Another example is that in a given system it is defined that the name of an employee can consist of no more than 50 characters. The maximum allowed number of characters is meta-data.

First (1st) order data on the other hand describe specific things that apply only to instances: the actual postal address (Frydenlunds allé 6, 2950 Vedbaek), the actual Employee Name (Lars Hansen) or the actual engine number (S/N 45 55 666). It is implied that data must always behave according to the specifications laid down in its meta-data. For example the Employee Name will have to comply with the rule that the number of characters does not exceed 50.

A configuration is a complete or partial specification of one or more pieces of generalized functionality and/or meta-data.

An Aspect Pattern is a kind of extended data type, in the sense that it represents a configurable solution to a general problem, and in the sense that it comprises business logic for the solution of the general problem. An Aspect Pattern comprises one or more generalized pieces of functionality. An Aspect Pattern further defines a set of meta-data that can be configured for that pattern. The Aspect Pattern defines the interpretation of a number of meta-data in an application. An Aspect Pattern further comprises Aspect connecting means and Aspect Event Type connecting means.

For example, an application may use an “Address Aspect Pattern” as well as a “Milestone Aspect Pattern”. The Address Aspect Pattern may comprise e.g., one or more pieces of functionality that knows how to handle a telephone address e.g., it comprises functionality that knows how to: call a telephone number, verify the number against the national telephone register, format the number for output, etc. The Address Aspect Pattern may also comprise one or more pieces of functionality that knows how to handle a postal address including e.g., a piece of functionality that can verify the address. All Aspect Patterns require broad interpretations to ensure that all problems that can be solved by the functionality of a particular Aspect Pattern also belong to this pattern. For example, the Value Aspect Pattern may be used to calculate various values on the basis of other values or to estimate costs. By value is meant traditional values such as price, VAT and discount, but also more abstract values such as working hours.

An Aspect Pattern comprises one or more Aspect Types. An Aspect Type is a specification of the Aspect Pattern. Therefore, for the various Aspect Types it is decided which pieces of functionality the Aspect Type may use. Each Aspect Type defines the meta-data of the 1st order data at runtime.

For example, an application that uses the “Address Aspect Pattern”, as explained above, may further use some specifications of the “Address Aspect Pattern” e.g. an Aspect Type “Home address” and an Aspect Type “Bill to address”. For each Address type, the functionality within the Address Aspect Pattern is specified in greater detail. The Address Type “Home address” may for example, be defined so that it can use only the “postal address” piece of functionality within the Address Aspect Pattern, whereas the Aspect Type “Bill to address” can use either the “Postal Address” or the “E-mail address” pieces of functionality. That is, pieces of functionality are configured in an Aspect Type, e.g. the Address Type “Home address” is configured to only encompass the “postal address” functionality. For an Identification Aspect Pattern comprising functionality that enables automatic creation of an identifier, an Aspect Type could be specified by the particular way the identifier shall be created (e.g. whether the identifier uses numbers that are created from a number series or a random number generator).

Business Object Type: A Business Object Type is an object type that represents a concept or entity within the scope of the real world. Typical examples of Business Object Types are: Employee, product, invoice, payment, debtor, creditor, and orders. A Business Object Type comprises Business Object Type connecting means.

By connecting one or more Aspect Types with a Business Object Type, a Configured Business Object Type with one or more configured Aspect Types is created. That is, the Aspect Type's Aspect connecting means are connected with the Business Object Type connecting means.

For example in an application a Business Object Type “Customer” may need a home address, hence, the Aspect Type “Home address” must be configured with the Business Object Type “Customer”. In this way a configured Business Object Type “Customer” is obtained. The Configured Aspect Type will then be the “Customer's Home address”.

A Business Object Instance is an instance of the configured Business Object Type. For example, a Business Object Instance of the configured Business Object Type “Customer” could be Navision Software A/S available from Navision of Denmark.

An Aspect Instance is one or more 1st order data of a Configured Aspect Type created at runtime. For example, the “Home Address for a specific Customer” may be “Frydenlunds Allé 6, 2950 Vedbaek” An application comprises a number of configured Business Object Types. An outline of the principle of the model of configuring is illustrated in FIG. 1. The model should be interpreted in the following way.

An Event Type (10, 12, 14) is configured with a configured Business Object Type 16 and defines possible occurrences to which an Aspect Pattern (18, 20, 22) may react. Each Event Type 10 comprises Event Type connecting means 24. Either a user or the system can trigger an Event Type to firing an Event Instance. An Event Instance is an occurrence of an Event Type. An Event Type may be fired zero or a number of times. The actual communication between the Aspect Instances is carried out through Event Instances. The Event Types (10, 12, 14) are configured with the specific Business Object Types. Thus, the Event Types 10, 12, 14 control the dynamics of the Business Object Types 16. E.g. an Event Type for the Business Object Type “Invoice” could be “payment due” and an Event instance thereof would then be triggered by a piece of functionality within the Aspect Pattern that has been configured with the “payment due” Event Type the actual date a Business Object Instance (i.e. a specific Invoice) has payment due. Also, an Address Aspect Pattern may have a piece of functionality that enables checking of a postal address in an official register. It is then possible to create an Event Type that triggers the piece of functionality that checks the postal address in an official register. An Event Type for the configured Business Object Type “Customer” could then be “Address verification”, and it would trigger the postal address check. The “Address verification” Event Type can then be configured to be either a system triggered Event Type or a user triggered Event Type.

The business logic (i.e. the functionality of an Aspect Pattern) can take action when an Aspect Instance of the Aspect Pattern receives a specific Event Instance. The event mechanism serves to fully insulate Aspect Types. In the present description, the Aspect Types are referred to as being illustratively disjoint, which means that the single Aspect Type does not know about the data or logic of any of the other Aspect Types, or even if another Aspect Type exists. Likewise also the Aspect Patterns are illustratively disjoint. This is an advantage since it provides for plugging a new Aspect Pattern into a running system without having to make any other changes to the system than those regarding the new Aspect Pattern and its Aspect Types thus facilitating upgrades by eliminating the possible side effects, since none of the other Aspect Types have to be reconfigured.

For example, it will be a user of the application that fires an Event Instance of the Event Type “Address verification”, configured as a user triggered Event Type. When the Event Instance is fired, it will then trigger the postal address check in the Address Aspect Pattern. Hence, neither an Event Type nor an Event Instance has any functionality. They solely comprise information about which Configured Aspect Types they may trigger by the configuration of the Event Type connecting means, thus triggering the functionality in the Aspect Pattern of the Configured Aspect Type, as illustrated in FIG. 1.

In order to ease reading of the following, an outline of the principle of the model of configuring a Business Object Type 16 may be applicable with the present invention is shown as FIG. 1. As shown in FIG. 1, for each Aspect Pattern 18, 20, or 22 one or more Aspect Types 26, 28, 30 may exist. As explained earlier, an Aspect Type is a specification of an Aspect Pattern. The specified piece(s) of functionality that should be executed when an Event Type is triggered comprises Aspect Event Type connecting means 32. In an embodiment in connection with the invention the Aspect Event Type connecting means 32 and the Event Type connecting means 24 each comprises a unique Aspect Event Type ID, and respectively, a unique Event Type ID. Setting the Event Type ID and identifying which pieces of specified functionality within one or more Aspect Types (comprised in one or more Aspect Patterns) that should react when the Event Type is triggered then configures the effect of an Event Type. Arrows in between the Event Type connecting means 24 and the Aspect Event Type connecting means 32 thus indicate the configuration. The Aspect Event Types IDs that correspond to these pieces of specified functionality are then set to the same as the Event Type ID. For example, a “Postal address” Aspect Type comprises a piece of “verification” functionality that should be triggered when an Event Type “Create customer” with an Event Type ID e.g. “1” is triggered, thus the Aspect Event Type ID that is comprised in the “verification” piece of functionality should also be “1”. Other pieces of functionality within the “Postal address” and/or other Aspect Types may also need to be triggered, thus their Aspect Event Type IDs should also be “1”.

The actual configuration of a Business Object Type 16 is carried out by joining the Business Object Type connecting means 34 with the Aspect connecting means 36 and the Event Type connecting means 24. In an embodiment useful with the invention the Business Object Type connecting means 34 and the Aspect connecting means 36 each comprises a Business Object Type ID, and, respectively, Aspect ID. The configuration of a Business Object Type 16 is then carried out by creating an entry with the Business Object Type ID, the one or more Aspect IDs and the one or more Event Type IDs in e.g. a Database as shown and described in greater detail below with respect to FIG. 5. Arrows between the Aspect connecting means 36 and the Business Object connecting means 34 and arrows between the Business Object Type 16 and the Event Types 10, 12, 14 indicate a configuration.

In FIG. 1 the configuration of only one Business Object Type 16 is illustrated, though a number of Business Object Types can actually be configured in the same way (i.e., by using the same Aspect Pattern and their Aspect Types).

In order to make two or more Business Object Instances interact, a “Relation” Aspect Pattern is implemented in an embodiment useful with the invention. In addition to the Aspect connecting means 36 the “Relation” Aspect Pattern further comprises related relation connecting means (related relation type IDs) that can be configured to one or more (relation) Aspect connecting means 36 thereby creating a connection between the Business Object Types.

The “Relation” Aspect Pattern further comprises one or more pieces of functionality that may react when a Business Object instance receives an Event Instance and one or more pieces of functionality that enables it to propagate another Event Instance to a related Business Object Instance. For example, if a technician should be allocated to a service job, a Business Object Type “Employee” should be related with the Business Object Type “Service Job” by configuring the “Relation” Aspect Pattern with both Business Object Types. Thus, a Business Object Instance “Kim Jensen” of the Business Object Type “Employee” can be related with the Business Object Instance “SJ334455” with an Aspect Instance of the configured “Relation” Aspect pattern. Whenever an Event Instance is fired on one of the Business Object Instances, another Event Instance will be propagated to the other Business Object Instance.

It may be useful in some situations to retrieve a value from an Aspect Instance of one Configured Aspect Type and set the value on another Aspect Instance of a Configured Aspect Type. This is achieved by configuring a “Propagated Value” 40, 42, 44 to a Business Object Type as discussed with respect to FIG. 2. The configured Aspect Type where the Aspect Instance should be looked up and the configured Aspect Type where the Aspect Instance should be changed is specified during a configuration. An Aspect Pattern that can provide one or more values from its Aspect Instances comprises a piece of Expression functionality in its generalized functionality 33. The expression functionality provides for a specification of what part of the Aspect Instance that should be propagated. An Aspect Pattern that can set one or more values on its Aspect Instances comprises a piece of channel functionality. The channel functionality provides for a specification of what part of the Aspect Instance that should be changed. The Propagated Value (e.g., 40) comprises Source Aspect connecting means 46 and Target Aspect connecting means 48. To ensure that all values are up-to-date, all Propagated Values 40, 42, 44 are calculated when the Source 46 changes.

During a configuration of Propagated Values as illustrated in FIG. 2 a Business Object Type 16 is configured with zero or a number of Propagated Values (40, 42, 44). For each of the Propagated Values the Source Aspect connecting means 46 is connected with an Aspect Connecting means 36 of the Aspect Type (26, 28, 30) that the Value should be retrieved from. Likewise the Target Aspect Connecting means 48 is connected with an Aspect connecting means 36 of the Aspect Type 26, 28, 30 that the Value should be set on.

The Aspect Types 26, 28, 30 that the Source Aspect connecting means 46 and the Target Aspect connecting means 48 respectively are configured with may be configured with the same Business Object Type 16 or different Business Object Types. Thus, by using Propagated Values, values can be exchanged within a Business Object instance as well as between two Business Object Instances.

In an embodiment of the system useful with the invention the Source Aspect connecting means 46 as well as the Target Aspect Connecting means 48 each comprise a unique identifier, also as explained earlier, the Aspect connecting means 36 as well as the Business Object Type connecting means 34 also comprises a unique identifier. The configuration is then carried out by creating an entry that comprises the Business Object ID, the Source Aspect ID, which is set to the same ID as the Aspect Type that it should retrieve the value from, and the Target Aspect ID, which is set to the same ID as the Aspect Type that it should set the value on. Also in the propagated value the part of an Aspect Instance where the value should be retrieved from and, set, respectively, is specified.

For example, if the price of a service order should depend on the response time of the service order, so that a “short”, “medium”, and “long” response time would result in different prices, a Business Object Type “Service Order” may be configured with a “Response Time” Aspect Type comprising the response time of the service order, and a “Price” Aspect Type comprising the price of the service order. Whenever the response time of the service order in a “Response Time” Aspect Instance is changed, the price of the service order in the corresponding “Price” Aspect Instance should be recalculated based on the response time. This can be done by having an expression on the “Response Time”—Aspect Type called “Length” that may return one of the values “long”, “short” or “medium”. It would be part of the “Response Time”—Aspect Type's configuration that would determine whether the response time of the service order in the “Response Time” Aspect Instance is considered “long”, “short” or “medium”. The “Price”—Aspect Type can have a channel called “Quality of Service” that can receive any of the values “long”, “short” or “medium”. Based on the input, the “Price” Aspect Type recalculates the “Price” Aspect Instance according to the functionality in its Aspect Pattern and its configuration. The Propagated Value mechanism is responsible for passing the value from the “Response time” Aspect Instance to the “Price” Aspect Instance.

In addition to using the Propagated Value mechanism for propagating values between Aspect Instances another mechanism called the Rule-mechanism may also be used. The Rule-mechanism is based on expressions as described above but instead of pushing values actively between the Aspect Instances the expression is only calculated when the Aspect Instance needs the value. The rules are expressions that are stored within and handled by the configured Aspect Patterns 18, 20, 22. The rule mechanism is illustratively typically used instead of the Propagated Value mechanism when pushing the value is costly.

For example, a Business Object may be configured with an “Address” Aspect Pattern and a “Price” Aspect Pattern. When a “Price” Aspect Instance receives an Event Instance of the “prepare invoice” Event Type, it needs to know the distance from the head office to the address given in the “address” Aspect Instance in order to calculate the price. Only at the time when the “price” Aspect Instance receives the Event Instance of the “prepare invoice” Event Type will it invoke its rule and retrieve the “distance” expression of the “address” Aspect Pattern. While this mechanism will result in the “price” Aspect Instance having an undefined value until the time of receiving the Event Instance of the “prepare invoice” Event Type, it will on the other hand prevent the potentially costly distance calculation from taking place unless it is really needed.

A rule may be configured with an Aspect Pattern. A rule comprises one or more Rule Source connecting means. The rule further comprises an expression for calculating a value based on other values on the same or other Aspect Instances. The Rule Source connecting means comprises information of where the values that the calculation should be based on can be found.

In an embodiment useful with the invention the set of Aspect Patterns comprises a Relation Aspect Pattern, the Relation Aspect Pattern comprising: Aspect connecting means 36, one or more pieces of generalized functionality 33; wherein the pieces of generalized functionality 33 are adapted to be specified, thereby providing pieces of specific functionality, a related relation Aspect connecting means, and one or more Aspect Event Type connecting means 32 enabling that one or more pieces of functionality 33 can be triggered. It is an advantage of a system applicable with the invention that connections between one or more Business Object Types 16 may be created by configuring a relation Aspect Pattern. In this way all relations between Business Object Types and consequently also all their Business Object Instances may be handled in the same way because the relation Aspect Pattern only has to be implemented once, thereby providing less code and a more robust system. It is a further advantage that all relations between Business Object Types 16 are configured in the same way for the application developer.

A task is presented to the user of an application in the UI. A task could, for example, be “Start service job” or “Create Invoice”. In order to help the user complete the task, a task sequence comprising illustratively one or more tasks may be presented. For example, in order to complete the task “Create invoice” the user may need to select e.g. a specific job that has been carried out for a customer, fill in the recipient of the invoice, etc. A task sequence for guiding the user through the task “Create Invoice” can thus be carried out by first presenting the user to a task “Choose service job” further comprising a list of completed service jobs. Thereafter, a second task could be presented to the user like “Choose recipient” comprising, for example, a list of various addresses or contact persons related with the customer and a task ‘Create recipient”. Thus, a task as well as a task in a task sequence may initiate a new task sequence. Also, what may be the overall task, like “Create Invoice” in the above-mentioned example, may be a task in a task sequence for another task sequence. For example the task “Close Service Job” may initiate a task sequence comprising the task “Create Invoice”.

In a feature of the present invention related to configuration of an application, a set of task patterns may be provided. A task pattern comprises a sequence of one or more task step patterns. A task step pattern may be used in one or more task patterns. For example, a “Select” task step pattern may be used in a “Modify” Task Pattern as well as a “Delete” Task Pattern.

By connecting a Task Pattern (a set of Aspect Patterns) with a Business Object Type 16 and specifying a name for that connection a Task may then at least be partly configured. If, for example, the Business Object Type “Invoice” is connected with a Task Pattern “Create” (the task pattern comprising the task steps “Create” and “View”) and named “Create Invoice”, a task “Create Invoice” comprising the Task steps Create and View is configured. At runtime a Task “Create Invoice” may then be presented to a user of an application. By choosing that task, a task sequence starting with the task “Create Invoice” will be presented to the user. When the user has completed creating the invoice, the next task step “View Invoice” will then be presented to the user.

Furthermore, a computer system in accordance with present invention may illustratively comprise a concatenated task pattern that can be configured by selecting a set of tasks (i.e. configured task patterns) thus forming a concatenated task comprising all the task steps of the original tasks. However, one or more of these task steps may be redundant to the user of an application. In order to spare a user of an application the redundant task steps, the concatenated task pattern comprises functionality that finds out whether there is already sufficient information in order to proceed to the next task step. A way to determine whether a task step is redundant can be by checking if the following task step could carry out its functionality with the available information. For example, if a task “Create and Print Invoice” should be available to a user of an application, this may be configured by a concatenated task by use of a “Create” Task Pattern and a “Print” Task Pattern. The Task Pattern “Create” comprises the task steps “Create” and “View”, and the Task Pattern “Print” comprises the task steps “Select” and Print, thus the “select” task in the “Print” Task Pattern can be skipped since a Business Object Instance is already identified in the previous task steps (“Create” and “View”).

In an embodiment of the invention, redundant task steps are identified and left out when the configuration is designed. This is an advantage since the application developer may view how the Task will be presented to a user of the application. In another embodiment of the invention, any redundant task steps will be identified at runtime. This is an advantage since the risk of leaving a task step out that should have been presented to the user is minimized.

An activity center comprises a group of tasks that can be presented to a user of an application. When configuring an activity center a name is assigned (e.g. “Sale”) and the user profiles (profiles for users of the application that have permissions thereto) may also be set up. In a illustrative embodiment of the invention, the users are grouped into different roles, wherein users of a given role have access to one or more activity centers. The application developer configures which tasks (such as configured task patterns) that are used in an activity center. A task based on a Task Pattern can be configured as a hot task meaning that the first task step in the task pattern immediately is presented to the user. Non-hot tasks may appear as hyperlinks to the user.

As part of the configuration, a view is illustratively connected to each task step, the view defining what information of the Business Object that shall be presented to a user of the application in the task step. The information may, for example, be whether an element should be shown, such as whether data of the Business Object Instance and its corresponding meta-data should be shown. In a illustrative embodiment of the invention part of an Aspect Pattern (illustratively part of an Aspect Type 26, 28, 30 configured with the Business Object Type 16) can be set as default members of a view. It is also possible for the application developer to create a customized view. In a illustrative embodiment of the invention a default view per task step may be generated automatically (e.g. by use of a view wizard). The application developer may then change the views on the single task steps.

In an embodiment in connection with the invention a system is provided wherein the set of Aspect Patterns 18, 20, 22 further comprises a plurality of Aspect Patterns each of said Aspect Patterns comprising one or more pieces of generalized functionality 33; wherein the pieces of generalized functionality 33 are adapted to be specified, thereby providing pieces of specific functionality, Aspect connecting means 36, one or more Aspect Event Type connecting means 32 enabling one or more pieces of functionality 33 to be triggered. By providing a plurality of Aspect Patterns 18, 20, 22 the application developer is provided with more predefined functionality, thus facilitating the actual configuration of applications.

Illustratively, a plurality of the Aspect Patterns in the set of Aspect Patterns comprises meta-data 50. In this way connections between functionality 33 and meta-data 50 within an Aspect Pattern 18, 20, 22 may be provided. This provides for the functionality 33 within an Aspect Pattern to be specified when configuring by only specifying and/or adding meta-data 50.

Furthermore, the at least one Aspect Pattern 18, 20, 22 may illustratively comprise an Aspect Interface 52. Illustratively, a plurality of Aspect Patterns 18, 20, 22 in the set of Aspect Patterns comprise the Aspect Interface 52. This is an advantage since a new Aspect Pattern easily can be added to the set of Aspect Patterns as long as it implements the same Aspect Interface 50.

In the illustrative embodiment or other embodiments applicable with the invention a design component (described in greater detail with respect to later Figures) further has access to, or is illustratively provided with, source Aspect connecting means and target Aspect connecting means and the set of Aspect Patterns further comprises, one or more Aspect Patterns comprising, a piece of Expression functionality, and one or more Aspect Patterns comprising a piece of Channel functionality, thereby providing exchange of values between Aspect Instances. This is an advantage since it ensures that all values that have been configured in this way are updated whenever a change in the source Value happens. Also, it is an advantage that an Aspect Instance may retrieve values in other Aspect Instances and still keep the Aspect Instances as well as the Aspect Types 26, 28, 30 and the Aspect Patterns 18, 20, 22 loosely coupled.

In embodiments useful with the invention a system in which the set of Aspect Patterns further comprises one or more Aspect Patterns comprising Rule Source connecting means is provided. It is an advantage to use a rule (or rules) in cases when, for example, the number of values that should be retrieved in order to calculate the expression is high and in cases when there is no reason for updating the value in the Aspect Instance before it should be used.

In embodiments applicable with the invention, a system is provided in which the design component is used for, or designed to be used for, configuring a plurality of Business Object Types 16. It is an advantage to configure a plurality of Business Object Types 16 by using the same set of Aspect Patterns since it facilitates upgrades of the system.

Also a system is useful with the invention wherein at least one Aspect Pattern 18, 20, 22 within the set of Aspect Patterns comprises one or more Aspect Types 26, 28, 30, each Aspect Type being a specification of the Aspect Pattern 18, 20, 22. In this way the application developer may be provided with one or more partial configurations of one or more Aspect Patterns thus facilitating the configuration for the application developer. Illustratively a system wherein the Aspect Types are designed to be configured with one or more Business Object Types is provided. This is an advantage since it provides for reuse of Aspect Types 26, 28, 30 between Business Object Types 16.

In embodiments in connection with the invention, a system is provided wherein the Business Object Type connecting means 34 comprises an identifier, BOTID, uniquely identifying the Business Object Type 16. The invention is also useful with a system wherein the Aspect connecting means 36 comprises an identifier, ATID, uniquely identifying the at least one Aspect Pattern and a system, wherein the Aspect Event Type connecting means 32 comprises an identifier, (A₁ETID₁A₁ETID₂ . . . ,A_{N}ETID₁, A_{N}ETID₂), uniquely identifying the one or more pieces of functionality 33 that can be triggered in said Aspect Pattern. The invention is applicable with a system, wherein the Event Type connecting means 24 comprises an identification number, ETID, uniquely identifying the Event Type 10, 12, 14. It is an advantage to use identification numbers, IDs, when the actual configuration of an application is implemented in, for example, a relational database.

Also systems may be useful with the invention wherein the Event Type 10, 12, 14 can be user fired. In this way a user may initiate one or more pieces of functionality 33 within one or more Aspect Patterns to be executed. Also, systems are applicable with the invention wherein the Event Type can be fired by a piece of functionality 33 within the Aspect Pattern it is configured with. This is an advantage since the system may initiate one or more pieces of functionality 33 within one or more Aspect Patterns to be executed. By configuring Event Types 10, 12, 14 as user fired or system fired or both it is possible to control what pieces of functionality that may be triggered by the user, the system or both.

Embodiments of a system in connection with the invention is provided wherein the design component further has access to or is provided with a set of pre-configured Business Object Types. The pre-configured Business Object Types may advantageously be configured with one or more Aspect Patterns that have been completely or partially configured, one or more Aspect Types that have been completely or partially configured, one or more Event Types that the Business Object Type may react on, one or more configurations of Event functionality within the one or more Aspect Patterns or the one or more Aspect Types. In addition a pre-configured Business Object type may be configured with one or more default values or rules. This is advantageously since the application developer does not need to configure the application from scratch.

In addition, the invention is useful with systems wherein the design component has access to or further comprises a repository component comprising meta-data of the application. Thereby the design component comprises the actual configuration of an application.

The present invention is applicable with a repository for an application in which a Business Object Type is based on at least one configured Aspect Pattern, said repository comprising one or more entries of configured Business Object Types. Each entry can comprise a Configured Business Object Type ID (BOTID) uniquely defining the configured Business Object Type; one or more entries of configured Aspect Patterns each entry comprising the BOTID and a configured Aspect Type ID (ATID) uniquely defining the configured Aspect Pattern; one or more entries of the configured Aspect Pattern, each entry comprising the ATID and meta-data specifying the configuration of the Aspect Pattern; and one or more entries of configured Event Types, each entry comprising the BOTID and an Event Type ID (ETID) uniquely defining the configured Event Type. It is an advantage that the repository for an application is structured in this way, since the Business Object Types do not need to know all Aspect Patterns in advance, thus facilitating upgrades of an application.

In one embodiment, a repository is provided further comprising one or more entries of configured pieces of Event functionality within an Aspect Pattern, wherein each of said entries comprises an Aspect Event Type ID. This is an advantage since an Event Type does not need to know of all the Event functionality in the Aspect Pattern in advance.

The invention is useful with a repository of the type outlined above and further comprising one or more entries of configured Propagated Values; each of said entries comprising a configured Business Object Type ID (BOTID) uniquely defining the configured Business Object Type, a Source Aspect ID (ATID) and a Target Aspect ID (ATID). In this way the Aspect Patterns do not need to know each other in advance, since all Aspect Patterns use the same mechanism for propagating values.

Furthermore, a repository can be provided wherein a part of the repository is a database. This is an advantage since currently a database provides for a more structured way of storing data. Illustratively each entry is a record in a table. In this way, new Aspect Patterns can be added easily.

A system can also be provided wherein the repository component is a repository as in any of the embodiments explained above.

The present invention is also applicable with a method for configuring a Business Object Type comprising the steps of specifying one or more pieces of functionality within one or more Aspect Patterns, connecting one or more Aspect Patterns with a Business Object Type, connecting one or more Event Types with the Business Object Type, connecting one or more Event Types with one or more pieces of functionality within one or more Aspect Patterns, thereby specifying/enabling one or more pieces of functionality within the one or more Aspect Patterns to be triggered by the one or more Event Types, whereby a configured Business Object Type is obtained. It is an advantage that the application developer does not have to follow a predefined order of how the Aspect Patterns and Business Object Types are connected, the Event Types and the Business Object Type are connected, the Event types are connected with the functionality in the Aspect Patterns and the specification of the functionality within the one or more Aspect Patterns.

The invention is also useful with a method, including steps of connecting an Aspect Pattern with the Business Object Type and specifying one or more pieces of functionality within each of the Aspect Patterns repeated n times. In this way the functionality within the Aspect Patterns is reused. Illustratively are method is used wherein n is a number in the group consisting of (2, 3, 4, 5, 6, 7, 8, 9, 10, 11, 12, 13, 14, 15, 16, 17, 18, 19, 20, 21, 22, 23, 24, 25, 26, 27, 28, 29, 30 or more).

Also the invention is applicable with a method, wherein one Event Type is connected with one or more pieces of functionality within one or more Aspect Patterns. This is an advantage since the complexity of an Event Type may vary depending on the application.

The invention in connection with a method is provided, wherein the step of connecting an Event Type with the Business Object Type is repeated m times. In this way Business Object Instances of the Business Object Type will be able to execute various Event Instances of the Event Types. Illustratively m is a number in the group consisting of (2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 or more).

The invention is useful with the method further comprising the steps of connecting a Relation Aspect Pattern with a first Business Object Type and connecting the Relation Aspect Pattern with a second Business Object Type thereby providing a connection between two Business Object types. This is an advantage since it provides for communication between Business Object Types.

The invention is applicable with a method; further comprising the step of specifying a number of meta-data in an Aspect Pattern. In this way the input of data at runtime are defined.

Also applicable with the invention are methods further comprising the steps of configuring Business Object Type connecting means with a Propagated value mechanism, by configuring Source Value connecting means with Aspect connecting means, thereby specifying where a value should be retrieved from configured Target Value connecting means with Aspect Connecting means, thereby specifying where the retrieved value should be set. In this way propagation of values between Aspect Instances at runtime can be performed. Also it is ensured that all values configured as target values are updated when the source values change.

Furthermore, the invention is useful with methods further comprising the steps of configuring an Aspect Pattern with Rule source connecting means, thereby specifying where a value should be retrieved from and an expression comprising the retrieved value so a value can be calculated and set on the configured Aspect Pattern at runtime. This is an advantage because values on an Aspect Instance that are configured with a Rule only will be updated when needed.

The invention can also include a method that comprises a step of storing the Configured Business Object Type in a Repository. Illustratively the repository is a repository according to any of the embodiments described above.

The present invention is applicable with a system for running an application, comprising a repository component comprising meta-data of configured Business Object Types, configured Aspect Patterns, and Event Types; a data storage component comprising 1st order data of Business Object Instances, Aspect Instances, and Event Instances; and a Business Object Controller (BOC) component handling the propagation of Event Instances between Aspect Instances. In this way the actual configuration of an application is held in the repository and the instances thereof are held in the data storage component. The dynamics are controlled by the BOC. This is an advantage since the Aspect Patterns do not need to know the other Aspect Patterns' configurations. Illustratively the repository is a repository as described in any of the above-mentioned embodiments.

In illustrative embodiments useful with the invention a system is provided wherein the BOC component further comprises a BO component and an Aspect Pattern Component. The BO component and the Aspect Pattern Component operate on data in the repository component and the data storage component. This is an advantage since the only changes that have to be made in the BOC when a new Aspect Pattern is added will be in the Aspect Pattern Component.

In this and other embodiments connected with the invention a system is provided wherein the repository component further comprises meta-data for the configured Propagated Values in the Application, and the BOC component further handles the propagation of the configured propagated values. This ensures that all Values on Aspect Instances that have been configured as target values in the Propagated Values are updated when their source values change.

The invention is applicable with systems further comprising a temporary memory for loading data from the repository component and the data storage component. In this way higher performance can be achieved.

In such and further embodiments of the invention a system further comprises an Event Queue. This is an advantage since the Event Queue handles the order of firing Event Instances when, for example, the Event Instances are fired from a number of Business Object Instances.

The invention is useful with a method of running an Application, comprising the steps of: firing an Event Instance, the Event Instance comprising an Event Type ID uniquely identifying the Event Type, the Event Instance further comprising a Business Object Instance ID uniquely identifying the Business Object Instance that the Event Instance is connected with; and submitting the Event Instance to one or more Aspect Instances connected with the Business Object Instance. This is an advantage since only the Aspect Instances need to know how to respond to the fired Event Instance.

The invention is applicable with a method illustratively comprising the step of forwarding the Event Instance to an Event Queue Component, the Event Queue Component handling the order in which the Event Instance has to be fired. This is an advantage since in this way it is ensured that the Event Instances are fired in the right order.

The invention is also considered useful with methods wherein the submitted Event Instance is identical to the fired Event Instance.

The invention is applicable with a method wherein the Event Instance is a user-fired Event Instance. In this way a user of an application can trigger one or more pieces of functionality in the Aspect Patterns.

In such and other embodiments connected with the invention a method is provided wherein the Event Instance is a system-fired Event Instance. In this way the application can initiate execution of one or more pieces of functionality within an Aspect Pattern.

The invention is useful with methods further comprising the step of setting a value on the Aspect Instance in response to the functionality that has been performed as a response to the fired Event Instance. This is an advantage since changes to the Aspect Instance can be added by use of the Event functionality.

In such and other embodiments the invention is useful with a method wherein the propagation of Event Instances between Business Object Instances are based on the configurations of the Relation Aspect Pattern. In this way an Event Instance on one Business Object Instance can trigger one or more Event Instances on other Business Object Instances, thus enabling communication between one or more Business Object Instances.

The invention is useful with a method further comprising the steps of:

1. registering a change in a first Value within an Aspect Instance configured as a Source within a Propagated Value;

2. retrieving the first Value within the Aspect Instance; and

3. setting a second Value on an Aspect Instance configured with a Target based on the first value.

In this way it is ensured that values configured as target values in a Propagated Value are updated when their source values change.

The method applicable with the present invention may illustratively further comprise the steps of handling a rule configured with an Aspect Instance by:

1. retrieving a third value within an Aspect Instance configured as a source;

2. calculating a fourth value as a response to the third value; and

3. setting the fourth value on the Aspect Instance configured with the rule. In this way a value on an Aspect Instance configured with a rule is only updated when used.

In such embodiments connected with the invention a method further comprises the step of: loading data, information and functionality related to the Business Object Instance comprising the BOID and its configured Business Object Type comprising the BOID in a temporary memory. Illustratively a method is provided wherein the step of loading data and information and functionality related to the Business Object Instance further comprises: loading data and information and functionality related to Business Object Instances and their configured Business Object Types (comprising the BOID) in the temporary memory. In most cases this ensures that all related information that may be used in a transaction only has to be loaded from the repository and/or the data storage once.

In such and other illustrative embodiments useful with the invention, a method is provided further comprising the step of loading 1st order data from the temporary memory to the data storage component. In this way it is ensured that the data storage component may be updated when a transaction has successfully been executed.

### BRIEF DESCRIPTION OF THE DRAWINGS

FIG. 1 illustrates a configuration of a Business Object Type based on Event Types, Aspect Patterns and Aspect Types.

FIG. 2 illustrates a configuration of a Business Object Type as in FIG. 1, further comprising Propagated Values.

FIG. 3 is a block diagram of one embodiment of a computer environment in which the present invention can be practiced.

FIG. 4 provides an overview of the components that are used for designing an application as well as of the components that are used for executing an application.

FIG. 5 provides an example of a Database comprising the Repository Component as well as the Data Storage Component.

FIG. 6 illustrates the Business Object Controller (BOC).

FIG. 7 and FIG. 8 are examples of sequence diagrams illustrating different ways of handling the execution of Event Instances.

FIG. 9 is a sequence diagram illustrating how the Propagated Value mechanism works.

FIG. 10 is a sequence diagram illustrating how the Rule mechanism works.

FIG. 11 illustrates the UI component.

FIG. 12 is a sequence diagram illustrating how part of an automatic generation of a task sequence is performed.

FIG. 13 is a sequence diagram illustrating querying of an Event Type.

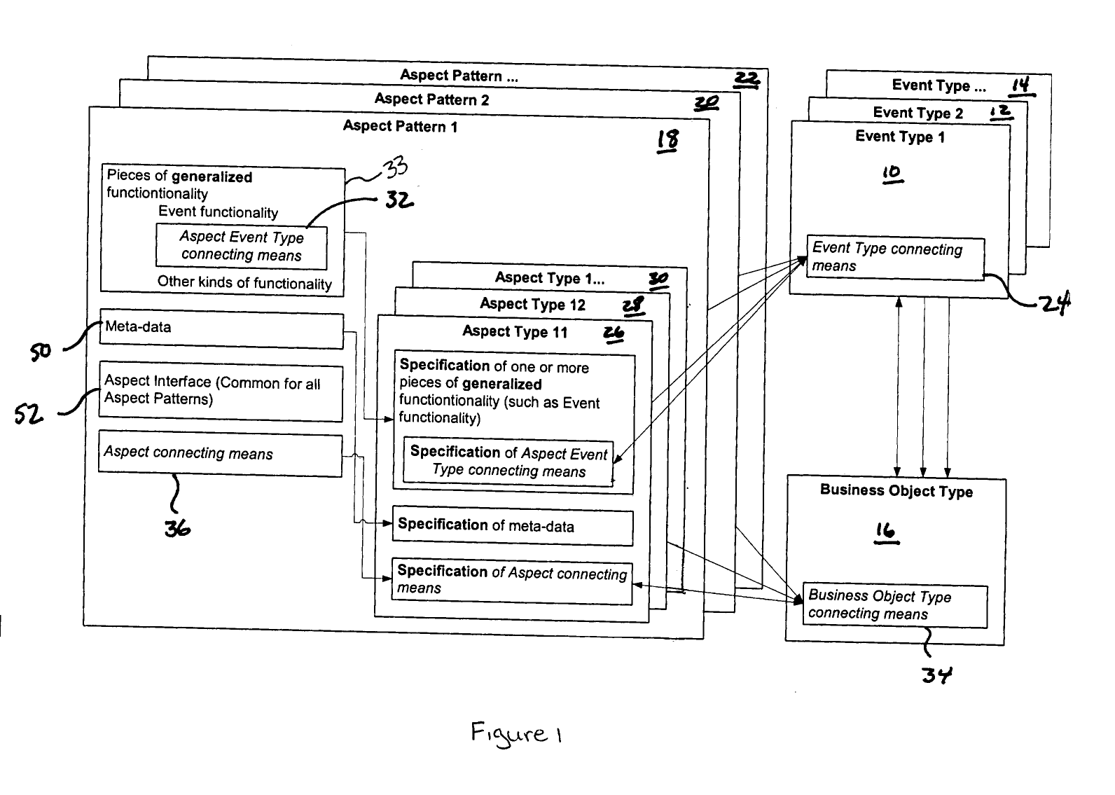

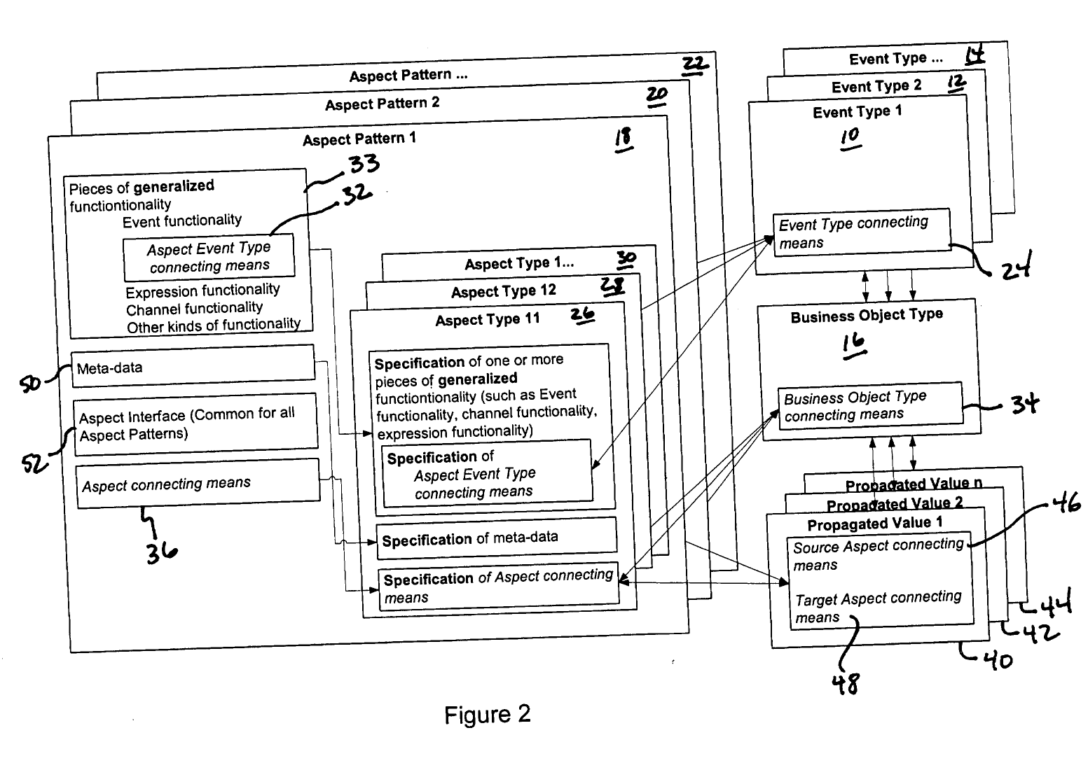

### DETAILED DESCRIPTION OF ILLUSTRATIVE EMBODIMENTS

In the following an implementation of a system architecture based on the terms defined above is presented.

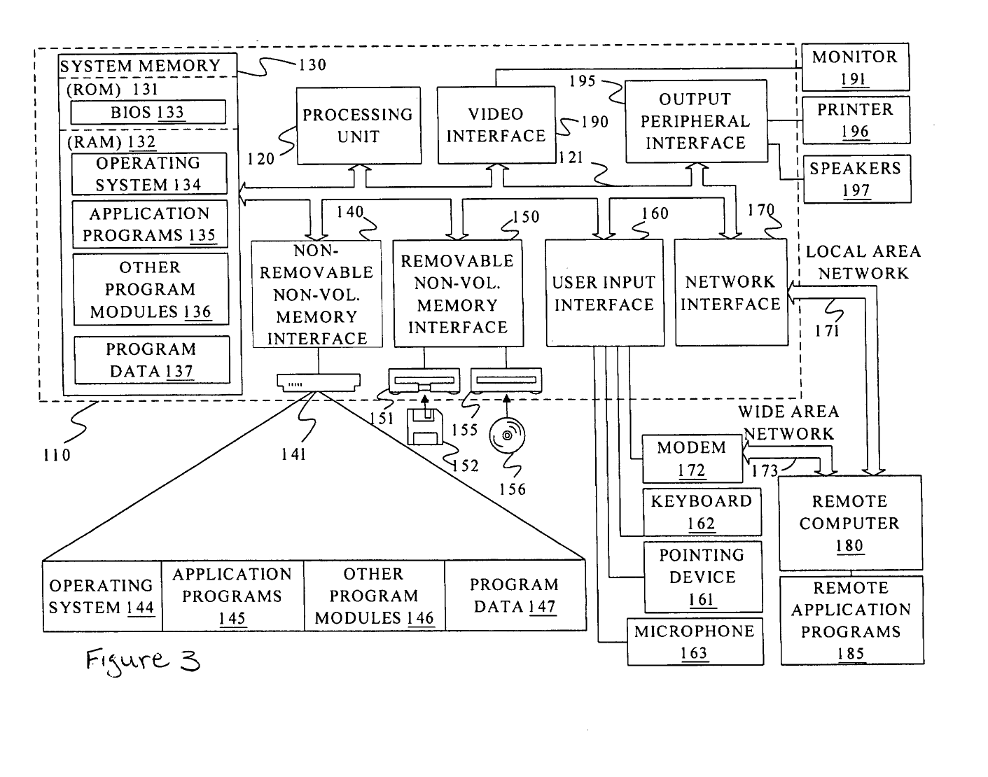

FIG. 3 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137.

The computer 110 may also include other removable/non-removable volatile/nonvolatile computer storage media. By way of example only, FIG. 3 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 3, provide storage of computer readable instructions, data structures, program modules and other data for the computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 3 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 3 illustrates remote application programs 185 as residing on remote computer 180. It will be appreciated that the network connections shown are exemplary and other means of establishing a communications link between the computers may be used.

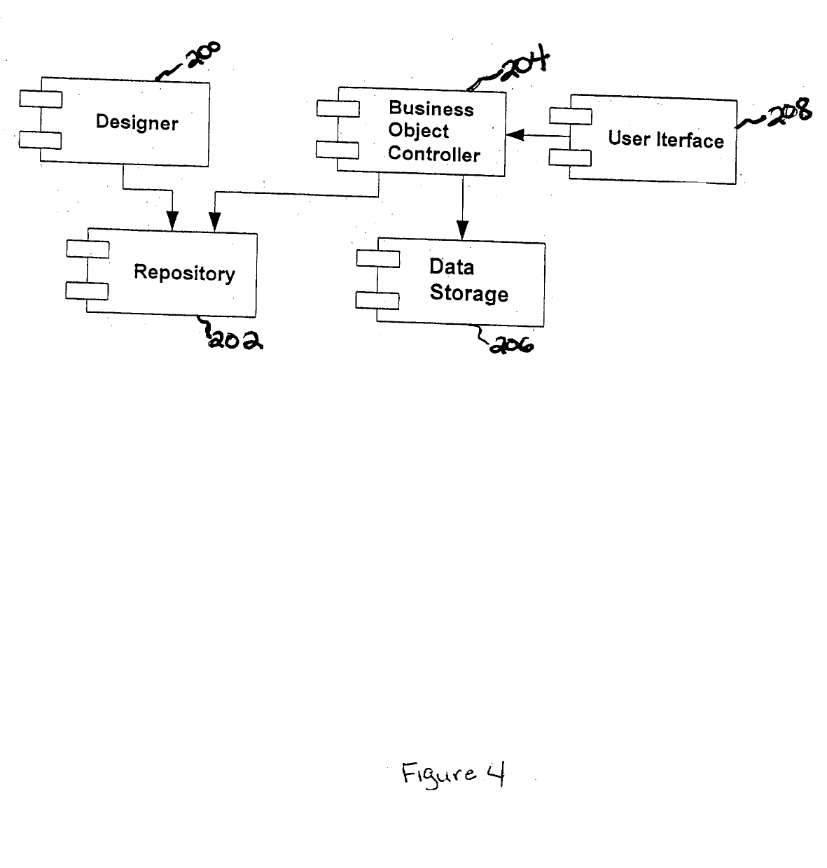

In FIG. 4 the components of the systems architecture are shown. The architecture includes design component 200, repository component 202, business object controller 204, data storage component 206 and user interface (UI) component 208. Every Aspect (either as Aspect Instance, Aspect Type, configured Aspect Type or Aspect Pattern) and Business Object (either as Business Object Instance, Business Object Type or configured Business Object Type) exists in each of the components shown in the figure. The figure shows dependencies of components indicated by the arrows (i.e. an arrow that points from one component to another indicates that the first component is using the functionality of the other component).

An application developer may use the Designer component 200 to create an application. The Designer 200 thus presents the application developer with the elements of the system architecture that may be configured in order to achieve an application.

The user interface 208 presents part of the actual application including runtime data (1st order data) to the end user.

The Repository 202 holds the meta-data of the system (i.e. the data of the Aspect Patterns, the Aspect Types, the Aspect Type Configurations, the Business Object Types and the Configured Business Object Types).

The Data Storage 206 holds the 1st order data of an application, (i.e., the Business Object Instances made up of Aspect Instances).

The Business Object Controller component 204 controls the business logic of the system (i.e., it controls the 1st order data of the system according to the meta-data laid down in the repository 202). Thus, the Business Object Controller 204 controls the dynamics of the system.

In a illustrative embodiment of the system's architecture all data in the repository 202 are stored in a database, but they could just as well be stored in, for example, a file (such as an XML file). This latter embodiment may be an advantage in cases where one or more users of an application do not have permanent access to the database of the application (e.g. in off-line situations) and where it is not feasible to install a relational database on the equipment they use.

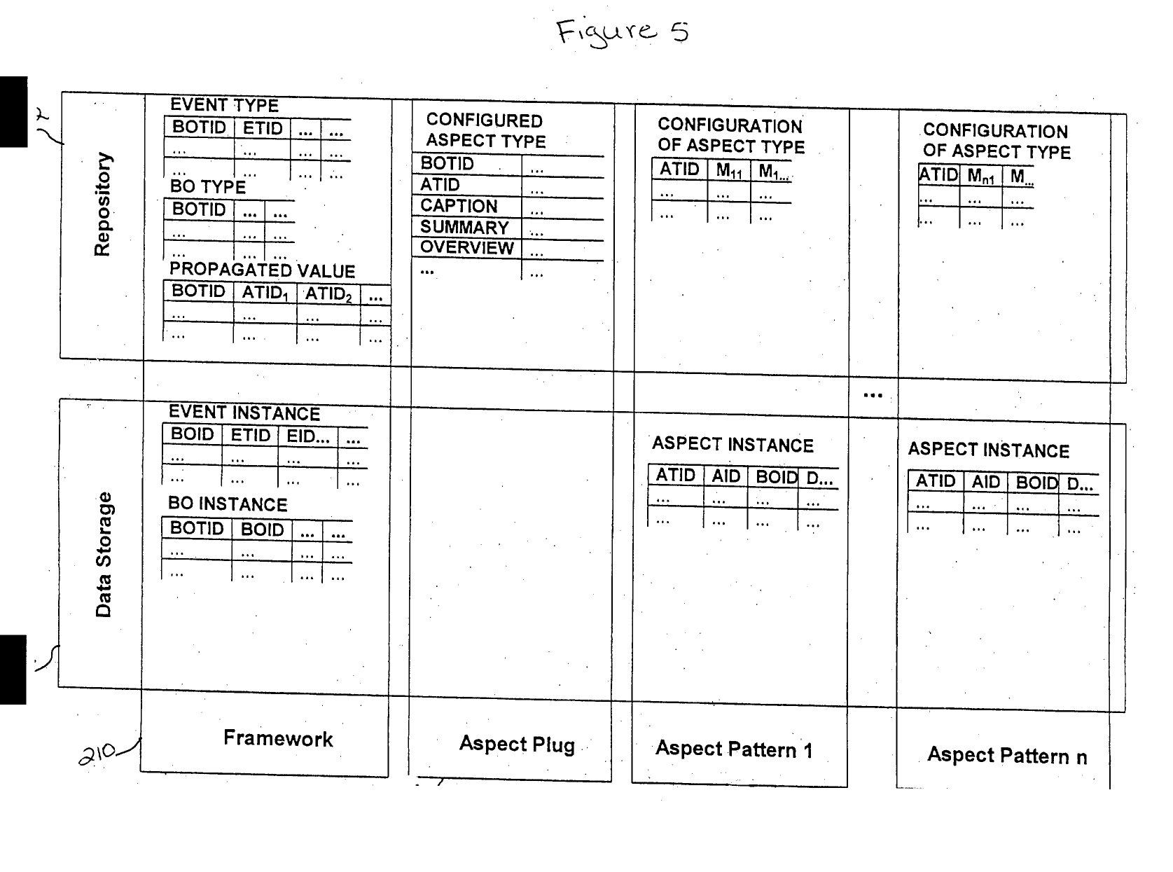

One exemplary layout of an embodiment of the Database comprising the Repository component 202 as well as the Data Storage component 206 is shown in FIG. 5. The Database is shown with a Framework part 210, an Aspect Plug part 212 and Aspect Patterns 18 and 22. The Framework part 210 and the Aspect Plug part 212 handle the configured Business Object Types and Business Object Instances. Each Aspect Pattern part comprises data characteristics for the corresponding Aspect Pattern. The data in the database are split in a Repository part 202 comprising all meta-data, and a Data Storage part 206 comprising 1st order data. Each part comprises one or more tables.

Within the repository part 202 of the database each Aspect Pattern comprises the meta-data specific for this particular Aspect Pattern. Each Aspect Pattern may comprise one or more related tables depending on the structure of the Aspect Pattern's specific meta-data. In the illustrative embodiment useful with the invention the Aspect connecting means 36 is an Aspect Type ID (ATID) that is used to identify the meta-data for a configured Aspect Type in its corresponding Aspect Pattern part. Thus, each Aspect Pattern comprises a table of configured Aspect Types for that Aspect Pattern that comprises zero or a number of entries comprising an Aspect Type ID (ATID) and one or more meta-data characteristics for the specific Aspect Pattern.

Each Configured Aspect Type comprises information of which pieces of functionality 33 that may be executed within its Aspect Pattern when an Event Instance of a specific Event Type is received. Also, the configured Aspect Type knows what piece of functionality 33 within the Aspect pattern an Event Instance can be fired from. For this purpose an Aspect Pattern may comprise one or more Aspect Event Type connecting means 32. In a illustrative embodiment applicable with the invention the Aspect Event Type connecting means 32 may be one or more Aspect Event Type IDs (A₁ETID₁, A₁ETID₂, . . . , . . . , A_{N}ETID₁, A_{N}ETID₂ . . . (not shown in FIG. 5)) and the Event Type connecting means 24 is an Event Type ID. The Event Type is then configured with one or more pieces of functionality 33 within one or more Aspect Patterns by making a reference between one or more of the Aspect Event Type IDs with the Event Type ID (ETID).

For example, if an address needs to be checked, an Event Type ID “Verify address” can be configured by relating it with the Aspect Event Type ID (e.g. A₂TID₅ which in FIG. 5 could be M₂₅) connected with a piece of functionality within an Address Aspect Pattern that verifies an address against a national register. Thus, the configured Address Aspect Pattern has an Aspect Event Type ID (e.g. A₂TID₅) “Verify address” referring to the Event Type ID “Verify address”.

The repository part 202 of the framework 210 comprises information of all configured Business Object Types and the domain of Event Types for each configured Business Object Type. In a illustrative embodiment useful with the invention the Business Object Type connecting means 34 is a configured Business Object Type ID (BOTID). The repository 202 for the framework part 210 comprises one or more tables comprising all configured Business Object Types in an application, the one or more tables comprising zero or a number of entries with the Business Object Types ID (BOTID). The repository part 202 also comprises one or more tables of all Event Types in the application, the one or more tables comprising zero or a number of entries with a BOTID and an Event Type ID (ETID). The repository part 202 further comprises one or more tables of the Propagated values. The one or more tables comprise zero or a number of entries comprising a Source Aspect ID (ATID₁) a Target Aspect ID (ATID₂) and a BOTID.

The Aspect Plug 212 comprises information of how the various Business Object Types are configured with the Aspect Types of the various Aspect Patterns. The Aspect Plug 212 in the repository part 202 comprises one or more tables of how all of the Business Object Types in an application are configured with the Aspect Types. These tables comprise zero or a number of entries comprising a Configured Business Object Type ID (BOTID) as well as the configured Aspect Type ID (ATID).

In a illustrative embodiment of the invention the Aspect Plug 212 also comprises, one or more entries identifying whether a configured Aspect Type and thus also Aspect Instances thereof may be included in the UI in various situations, such as a caption of the Business Object Type it is configured with and Business Object Instances thereof, a summary of the Business Object Type it is configured with and Business Object Instances thereof or an overview of the Business Object Type it is configured with and Business Object Instances thereof. For example, if a Business Object Type “Employee” should be created that comprises both a “Home Address” as well as an “E-mail address” a Business Object Type shall be configured in the Aspect plug 212, for example, by making one entry that comprises a BOTID (e.g. “Employee”) and an ATID “home address” and another entry that comprises the BOTID “Employee” and an ATID “E-mail address”. The ATID “home address” in the Aspect Plug 212 is referred to by the ATJD “home address” within the “Address” Aspect Pattern (e.g. corresponding to Aspect Pattern 1 in FIG. 5), which enables a postal address to be configured. Likewise the ATID “E-mail address” in the Aspect Plug 212 is referred to in the “Address” Aspect Pattern part with the ATID “E-mail address”. The actual configurations of the “Home address” and the “E-mail address” in the “Address” Aspect Pattern can then be found in one or more entries in one or more tables referring to the ATID “Home address” and, respectively, “E-mail address”.

In a illustrative embodiment useful with the invention the related relation Aspect connecting means of a “Relation” Aspect Pattern is a related relation Type ID. For example, if the “Relation” Aspect Pattern corresponds to Aspect Pattern 1 in FIG. 5, the related relation Type ID can be M₁₁ A relation between two Business Object Types is then configured by configuring a BOTID “1” with an ATID “1” that refers to the ATID “1” in the “Relation” Aspect Pattern and also configuring a BOTID “2” with an ATID “2” that refers to the ATID “2” in the “Relation Aspect Pattern”. A relation between the configured Business Object Type identified by the BOTID 1 and the configured Business Object Type identified by the BOTID 2 is then configured by setting the related relation Type ID, (e.g. M₁₁) to “2” for the entry comprising the ATID “1” and M₁₁ to “1” for the entry comprising the ATID “2”.

It is an advantage of the Aspect Plug 212 that a new Aspect Pattern can be added to the database without redesign of the database, since the only changes to the layout of the overall database would be the new Aspect Pattern (Aspect Pattern n+1) and adding standard information about the new Aspect Pattern to the Aspect Plug 212. This facilitates upgrades of the system. In a illustrative embodiment the standard information about the new Aspect Pattern is added in the Aspect Plug 212 by only adding one line in one table.

One embodiment of the data storage component 206 is also shown in FIG. 5. The Data Storage part 206 of the database comprises 1st order data of an application in one or more tables. The framework part 210 comprises one or more tables of all Business Object Instances of an application and also one or more tables of what Event Instances that have been fired. The actual Aspect Instances are stored in the corresponding Aspect Pattern parts of the Data Storage part 206 in the database.

From FIG. 5 it can be seen that the Data Storage part 206 of the Framework part 210 comprises one or more tables comprising Business Object Instances, the tables comprising zero or a number of entries with the BOTID and the Business Object instance ID (BOID) of the Business Object Instances of the Business Object Type. The Data Storage 206 can also have one or more tables of all Event Instances that have been fired, the tables comprising zero or a number of entries with the BOID, the ETID and an Event Instance ID (EID). Each of the Aspect Pattern Parts in the data storage (or runtime) part 206 comprises one or more Tables of it Aspect Instances comprising zero or a number of the ATID, an Aspect Instance ID (AID) and the BOID.

The layout of the Framework 210 is independent of the application. For instance, the Framework can be the same for such things as a Field Service Management Application and a General Ledger Application.

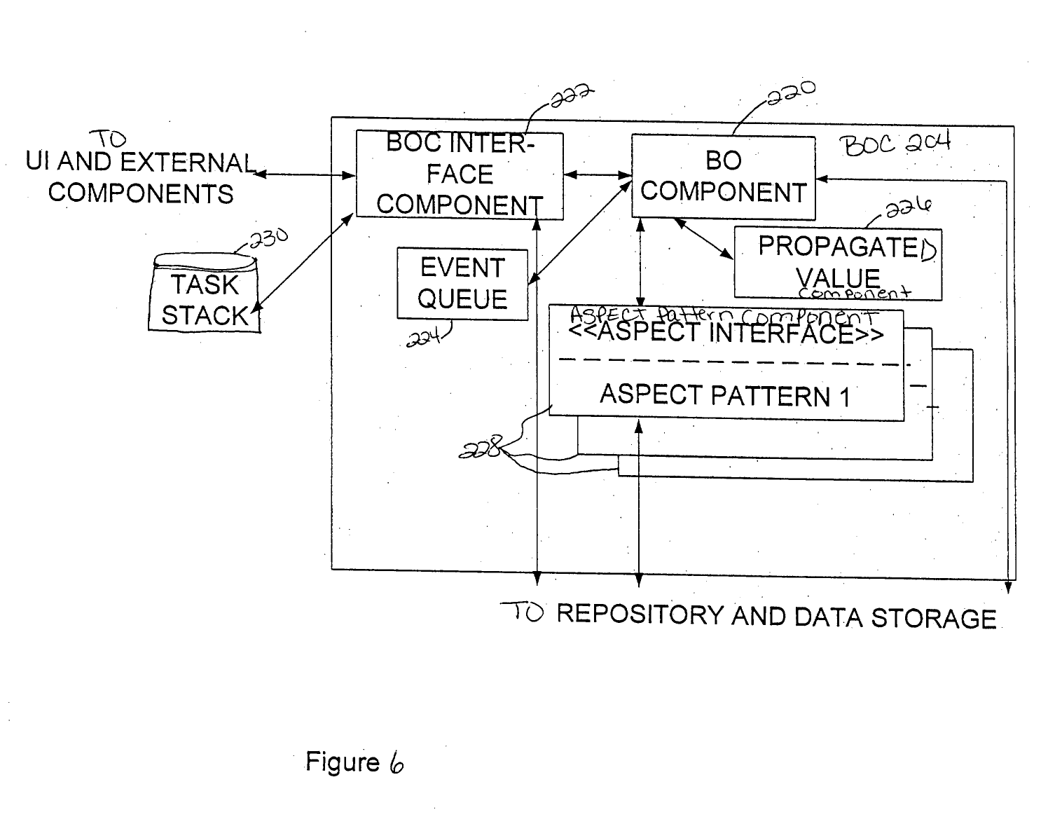

In FIG. 6 a more detailed outline of the Business Object Controller (BOC) 204 is presented. BOC 204 illustratively includes BO component 220, BOC interface component 222, Event queue 224, propagated value component 226, and one or more asepct pattern components 228. The BOC 204 exchanges documents with external components (such as the UI 208). It is the BOC Interface Component 222 that handles these operations. In the present system's architecture the BOC 204 is developed in code (such as Visual Basic, C#, Java etc.) and is executed on an application server.

The code that links the meta-data and the 1st order data of the single Aspect Patterns together is comprised in the Aspect Pattern Component 228. For example, the Aspect Pattern Component 228 reads in the Repository 202 and operates in Data Storage 206. In the illustrative embodiment of the system's architecture the Aspect Pattern Component 228 comprises one component for each of the Aspects Patterns, where each of the Aspect Pattern components 228 implements the same Aspect Interface. This enables the other components of the BOC 204 to interact with any Aspect Pattern Component 228 through its interface without knowing its implementation. This is an advantage since when a new Aspect Pattern is created the only changes that have to be implemented will be in the Aspect Pattern Component 228. Thus, the BOC 204 can easily be updated when a new Aspect Pattern has to be implemented. The Aspect Interface gives access to such functionality as sending and receiving Event Instances, propagating values through expressions and channels, as well as calculating rule expressions.

One of the main functions of the BOC 204 is to control the dynamics of the system. As mentioned earlier the dynamics of the system are managed by Events and propagated Values. For this purpose the BOC 204 further comprises Event Queue 224 that manages the Events and propagated value component 226 that manages the Propagated Values. The Events control the dynamics of the Business Objects (i.e. the Event Instances are connected to the actual Business Object Instances as shown in FIG. 5). The Event Queue 224 manages the order in which the Event Instances must be fired. In one embodiment, the Event Queue 224 sees to it that the first incoming Event Instance is the first one to be fired to the specific Business Object Instance. The following Event Instances will not be fired until the first Event Instance has been completed.

The Event Queue 224 receives the Event Instances through the Business Object (BO) component 220 which, in turn receives the Event Instances either from the Data Storage 206 or from an Aspect Pattern Component 220 which receives it from the Data storage 206. The Event Queue 204 then puts the Event Instance in a queue. The BO component 220 takes responsibility for examining the repository 202 to know which Event Types are configured with which Aspect Types.

In a illustrative embodiment of the invention the BOC interface component 222 interacts with a task stack 230 that keeps track of so-called sub-tasks started by the user of an application before finishing another task. The first task from which the sub-task was started is then said to be the calling task. As an example, such an embodiment will allow the user to start a “Lookup Customer” task from within the “modify” step of a “Modify Sales Order” task, and in turn start a “Create Customer” task from within the “select” step of the “Lookup Customer” task. Then the task stack 230 would contain three task states: Modify Sales Order in modify step->Lookup Customer in select step->Create Customer in create step.

In a illustrative embodiment the task stack 230 is persisted allowing each user to find and restart unfinished tasks.

Some examples of task patterns are shown in Table 1 below. As it appears from Table 1 a task pattern can be “Create” comprising the task steps “Create” and “View”. Another task pattern can be “Do Method” comprising the task steps “Select”, “Make Possible”, “Do” and “View”.

TABLE 1
Examples of task patterns

| | Task | | Task | Task |
|---|---|---|---|---|
| Task pattern | step 1 | Task step 2 | step 3 | step 4 |
| Create | Create | View | | |
| Modify | Select | Modify | View | |
| Delete | Select | Delete | | |
| Print | Select | Print | | |
| View | Select | View | | |
| Lookup | Select | | | |
| MakeConsistent | Select | MakeConsistent | View | |
| Transform | Select | Transformcreate | View | |
| Do Method | Select | MakePossible | Do | View |

The task steps may be split into two groups depending on whether the task step manipulates data or not. In an embodiment of the invention information that is obtained in a task (e.g. in a configured Task Pattern) is saved after completing each task step that manipulates data. In another embodiment of the invention information is saved when the entire Task has been performed.

In a illustrative embodiment of the invention all task steps comprise functionality enabling the user to either:

a) commit the task step thereby causing the sequence of task steps of the task to continue; or

b) cancel the task step, thereby aborting the current task, returning to the calling task on the stack.

Besides these methods, the single task steps can comprise functionality, as presented in Table 2 below.

TABLE 2
Example of functionality on task steps

| List of task steps | Functionality |
|---|---|
| Create | Allows for a user of an application |
| | to create a Business Object Instance |
| | of a Business Object Type |
| Select | Presents a set of Business Object |
| | Instances (e.g. originating from the |
| | same Business Object type the task |
| | has been configured with) allowing a |
| | user to select one of the presented |
| | Business Object Instances |
| View | Presents a Business Object Instance |
| | to a user of the application |
| MakeConsistent | Checks that all needed information |
| | (e.g. defined as part of a |
| | configuration) has been provided to |
| | the Business Object Instance |
| Transformcreate | Transforms a Business Object |
| | Instance originating from one |
| | Business Object Type to a new |
| | Business Object Instance (for |
| | example, Business Object Type such as |
| | a quote may be transformed into an |
| | order). |
| Print | Allows for printing of a Business |
| | Object Instance |
| Modify | Allows a user of the application to |
| | make changes to a Business Object |
| | Instance |
| Delete | Allows a user of the application to |
| | delete a Business Object Instance |
| MakePossible | Initiates a task sequence in order to |
| | be able to carry out one or more |
| | pieces of functionality of the |
| | Business Object Instance. In a |
| | illustrative embodiment this is done |
| | by letting the user bring one or more |
| | Aspect Instances of the Business |
| | Object Instance into a state where |
| | they can react to an Event Instance |
| | of an Event Type configured with the |
| | Business Object Type and the task |
| Do | Fires an Event Instance of the Event |
| | Type whereby functionality of the |
| | Business Object Type is carried out |

In a illustrative embodiment of the invention some of the following views may be assigned as default views to the various task steps, although these views are exemplary only and other views can be assigned as well. A “SearchResult View” may be used as default view in the task step “Select”. This view comprises information about the name and the ID of the Business Object Instances. An “Edit View” may be used as default view in the task steps “View”, “Modify”, “Create” and “Print”. This view presents all Aspect Instances of the Aspect types configured with the Business Object Type. A “Delete View” that shows an empty page title and includes the fields from the “Search Result View” may be used as a default view for the task step “Delete”.

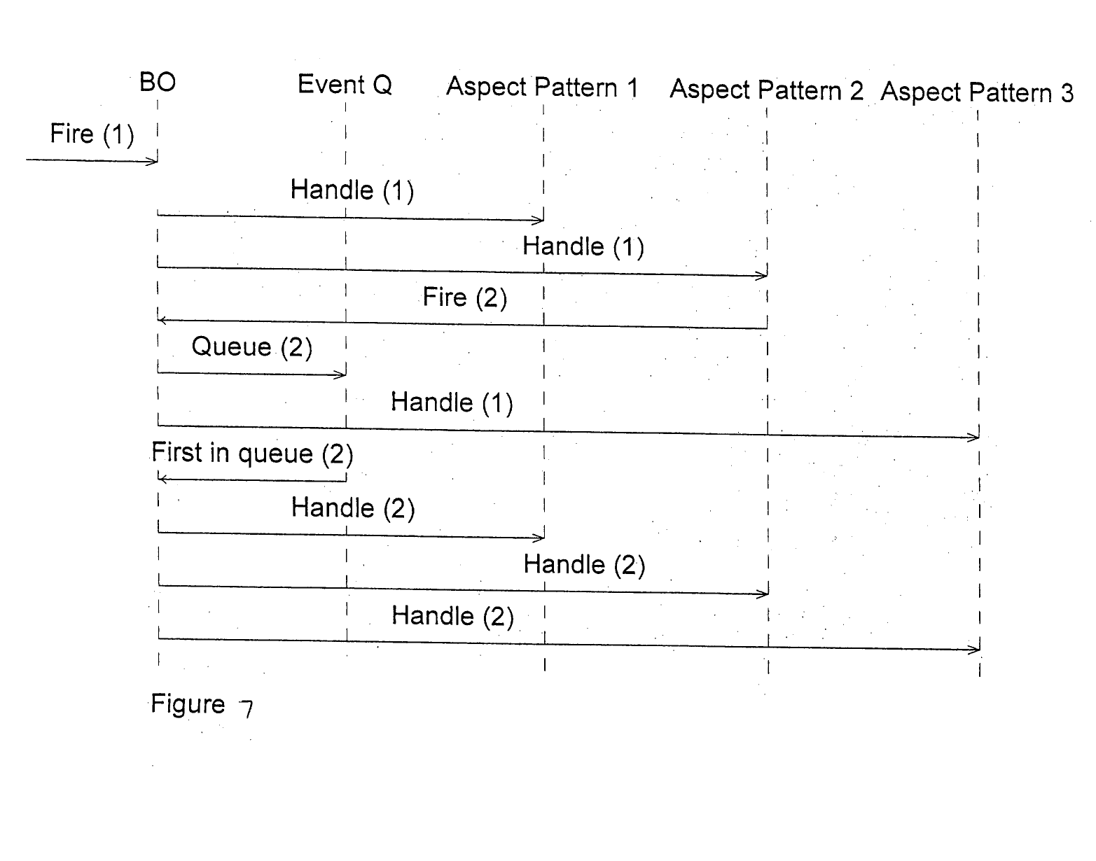

FIG. 7 shows one sequence diagram for handling firing of Event Instances. When the time has come to fire the Event Instance, the Event Instance is fired to the Business Object component 220 that passes the Event Instance via the Aspect Pattern Interface on to the Aspect Pattern Component 228. The Aspect Pattern Component 228 then takes care that the Event Instance is fired to the single Aspect instances within the specific Business Object Instance. The single Aspect Instances then determine whether they are configured with the Event Type that this Event Instance is an instance of). In FIG. 7 an Event Instance “1” is fired to the BO component 220 and then on to the Aspect Pattern component 228 for Aspect Pattern 1 and afterwards to Aspect Pattern 2. Aspect Pattern 2 then fires an Event Instance “2” as a response to receiving Event Instance “1” to the BO component 220. The Event Instance “2” is then put in the Event Queue 224. The BO component 220 continues to pass the Event Instance on to the remaining Aspect Patterns (through their corresponding Aspect Pattern components 228), in this case only Aspect Pattern 3. The Event Queue 224 then passes the first Event Instance in its queue on to the BO component 220 that passes the Event Instance on to all of the Aspect Patterns. In another embodiment the Event Instance is only sent to the Aspect Instances that are connected to the Event Instance.

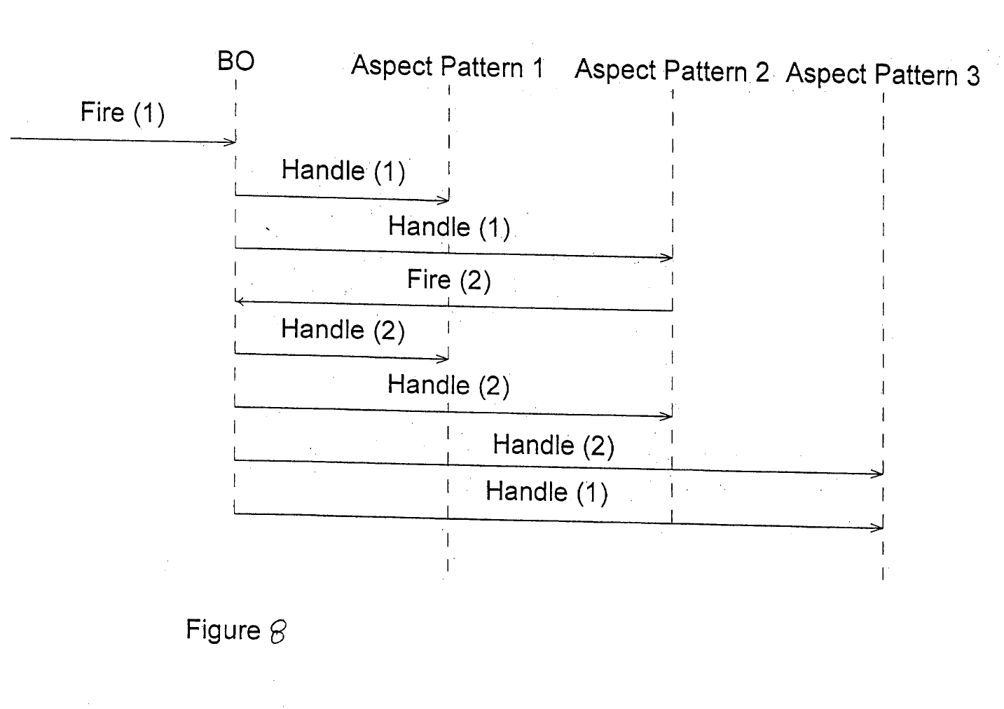

In another embodiment of the BOC 204 the BOC 204 does not comprise an Event Queue 224. The handling of Events in such a system is illustrated by the sequence diagram shwon in FIG. 8. In FIG. 8 an Event Instance “1” is fired to the BO component 220. The Event Instance “1” is then passed on to the Aspect Pattern 1 and Aspect Pattern 2 (again through corresponding components 228). Aspect Pattern 2 then fires an Event Instance “2”, in response, to the BO component 220. Hereafter the BO component 220 starts passing the Event Instance “2” on to all Aspect Patterns, in this case first to Aspect Pattern 1 then to Aspect Pattern 2 and finally to Aspect Pattern 3. The BO component 220 then finishes handling the Event Instance “1” by firing it to the remaining Aspect Patterns, in this case only to Aspect Pattern 3.

Firing an Event Instance is transactional. That is, unless it is possible to perform the entire process of firing an Event Instance, the system will return to the initial state as if the Event Instance had not been fired. During the response to an Event Instance an Aspect Pattern may fire another Event Instance, which is then queued until the first Event Instance has responded to all Aspects Patterns of the Aspect Instance configured with the given Business Object Instance. The transaction spawned by the original Event Instance, comprises Event Instances fired in reaction to the Event Instance. Likewise for the embodiment of the BOC 204 that does not comprise the Event Queue 224, the transaction spawned by the original Event Instance, comprises Event Instances fired in reaction to the Event instance.

Whenever a transaction is initiated a copy of all entries that comprise information about the one or more Business Object Instances associated with the transaction is loaded in the BOC 204. That is, all related Business Object Instances, which are used in the current transaction, are loaded. When a Business Object Instance is loaded all relevant information is also loaded. This may include, for example, configured Business Object Types, Event Types, configured Aspect Types, Propagated Values, Business Object Instances, Aspect Instances, and Event Instances. Propagating a value can also be considered part of a transaction.

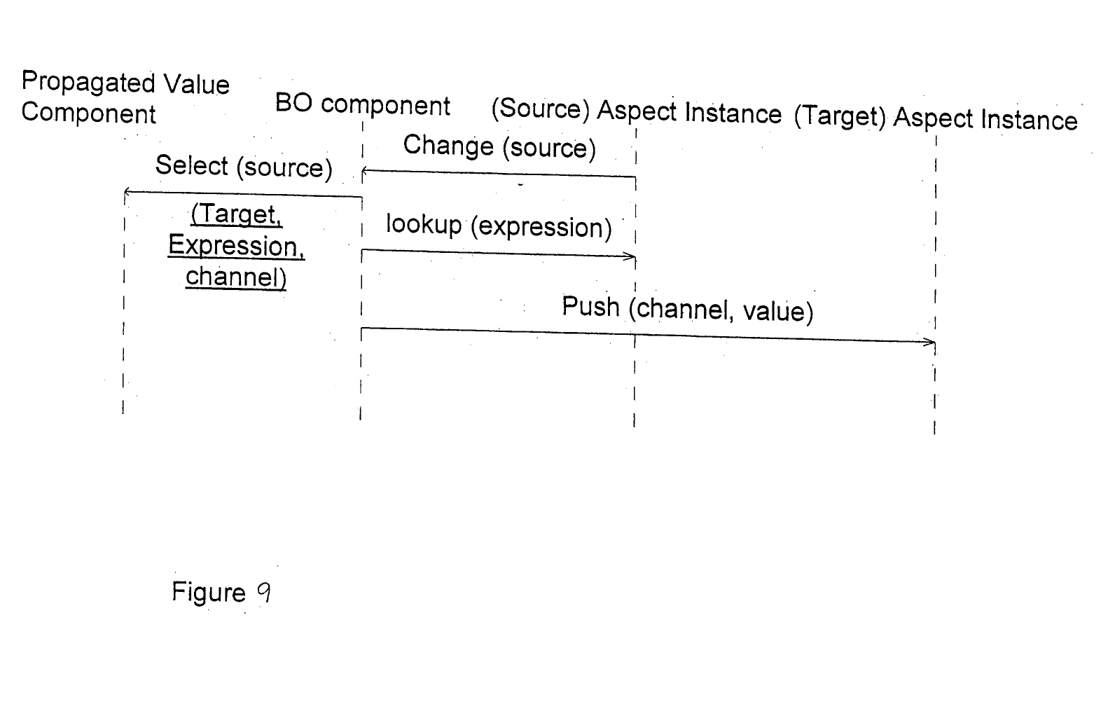

In FIG. 9 a sequence diagram showing the process of propagating a value is illustrated. When an Aspect Instance is changed a message is send to the B0 component 220 in the BOC 204. The BO component 220 then passes on a message to the Propagated Value component 226 that comprises information of what Aspect Instance has changed. The Propagated Value component 226 then finds all Aspect Instances that are targets for this change, if any, and returns the identification of these Aspect Instances to the BO component 220. The BO component 220 then pushes the values from the source Aspect Instance on to the target Aspect Instances through components 228.

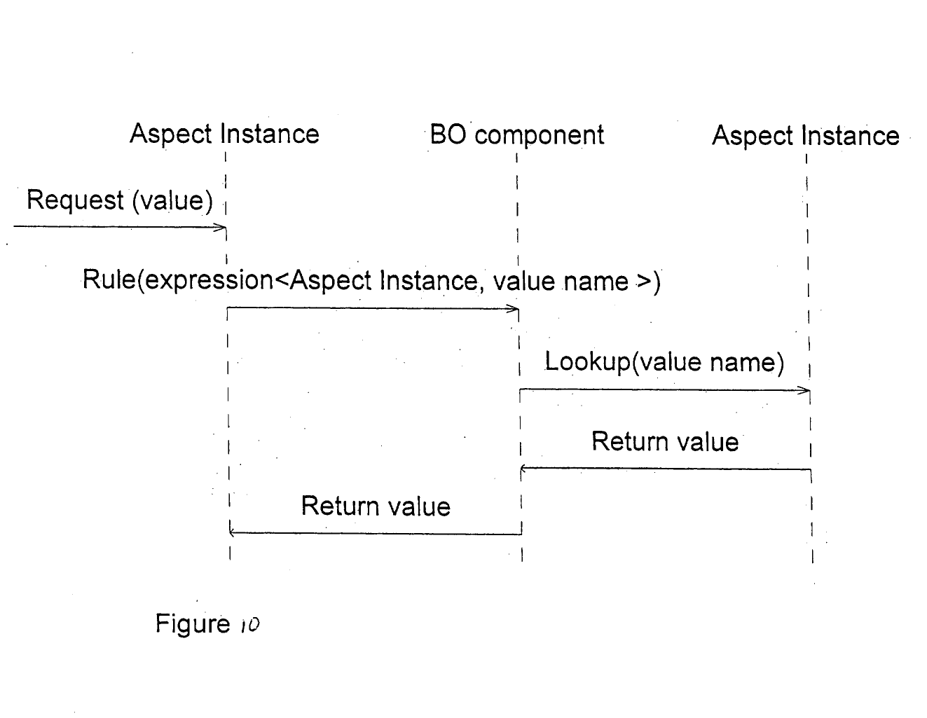

In FIG. 10 a sequence diagram showing the process of calculating a rule is illustrated. When a value on an Aspect Instance is requested, a message comprising information about the expression to be calculated and where the one or more values should be looked up, is sent to the BO component 220 in the BOC 204. The BO component 220 then sends a message to the specified Aspect Instance (through component 228) to lookup the value with the value name specified. The Aspect Instance thereafter returns this value to the BO component 220. The BO component 220 calculates the expression and returns calculated value to the Aspect Instance.

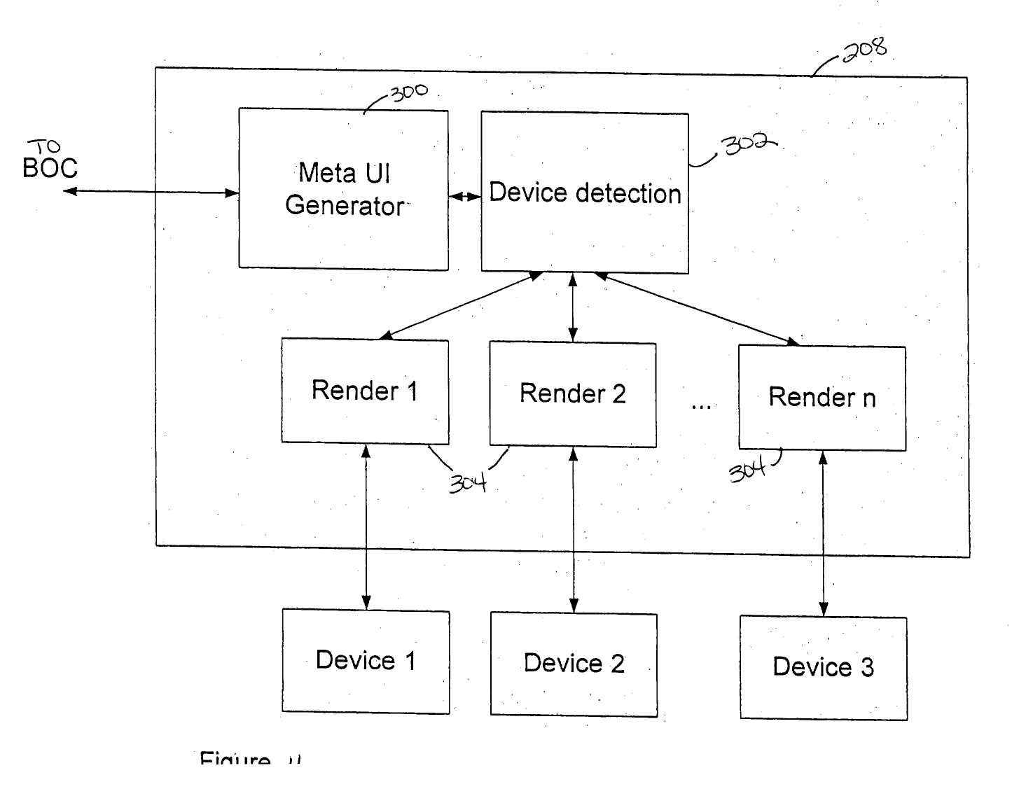

In FIG. 11 a more detailed outline of the UI component 208 is shown. The UI component 208 includes Meta UI generator 300, device detection component 302 and Rendering component 304. UI component 208 exchanges documents, such as eXML documents, with the BOC Interface 222. The documents from the BOC 204 are handled by a Meta UI generator 300 that interprets the information of the document from the BOC 204 and creates a document (such as a XML document) that describes and what information shall be presented to a user, and the way it shall be presented, for a number of devices that may be connected with the application. The document from the Meta UI generator 300 is sent to Device detector 302 that determines what kind of device the information shall be presented on and sends a document comprising information specific for the detected device to a render component 304 for the detected device. The render components 304 of the different devices comprise functionality that defines the layout of data (e.g. the layout of a string that should be presented as a header, etc.). The render component 304 of the device sends a document such as a HTML document to the device. In the presented system's architecture the UI component 208 is developed in code (such as, XML. XSLT, Visual Basic, C#, Java etc.) and is executed on an application server.

For example, in an embodiment in which a Business Object Instance shall be presented to a user, information from the BOC 204 comprising information about the Business Object Instance, its Aspect Instances, its configured Business Object Type and its configured Aspect Types is used by component 208. This information may include whether a configured Aspect Type and thus Aspect Instances thereof may be presented to a user as a caption or/and in a summary and/or in an overview of the Business Object Instance. The Meta UI Generator 300 then interprets the information. For example, in the configuration, the information related to a configured Business Object Type and its configured Aspect Types may be defined differently depending on what device the information shall be presented on. Therefore, a name of a Business Object Type may be “Invoice of Customer” when presented on a PC and “Invoice” when presented on, for instance, handheld device due to the limited space. Also, an Aspect Type may be configured to only be presented on a selected number of devices in some situations. All this information is then interpreted by generator 300 and a document is created and the rest of the process is executed, as explained above.

Illustratively part of all Event functionality within illustratively all Aspect Patterns is able to evaluate whether an Event Instance of an Event Type configured with the Event functionality can be reacted upon. Triggering such an evaluation is known as querying. The Aspect Patterns are able to return a message telling whether it is possible to react. Furthermore, an Aspect Pattern may be able to return messages indicating why the piece of Event functionality cannot react, such as, for example, due to the state of the Aspect Instance. Additionally, the Aspect Pattern may be able to return a task to make it possible to react, if it is currently not possible.

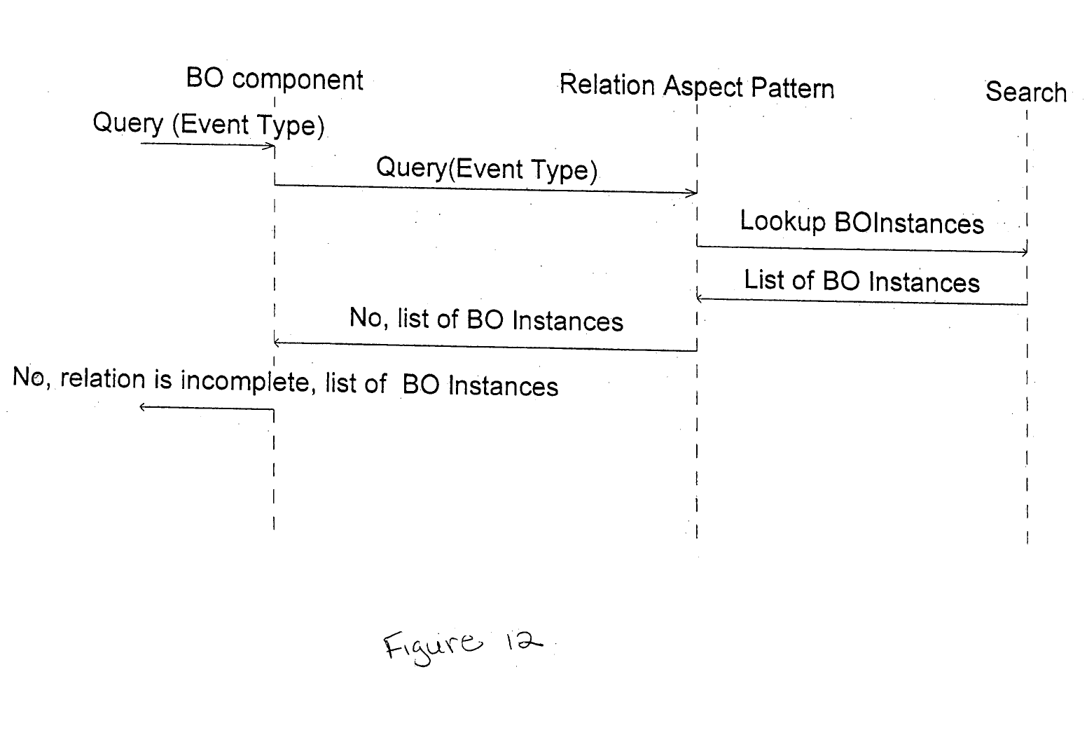

FIG. 12 illustrates a sequence diagram showing an example of how a part of a task in a task sequence is executed. A first configured Business Object Type is configured with a Relation Aspect Pattern and thus with a second Business Object Type through the related relation connecting means. A Business Object Instance thereof may need one or more relations to other Business Object Instances of the second Business Object Type. If a relation of the Business Object Instance of the first Business Object Type, for example, does not have a relation with another Business Object Instance of the second Business Object Type, the Relation Aspect Pattern may then ask a search component in the BOC 204 to find all Business Object Instances of the second Business Object Type that has been configured with the first configured Business Object Type. The Relation Aspect Pattern then returns a message comprising the information that the UI component 208 interprets to mean that it is not possible to fire the Event Instance and information that the UI component interprets as a list of possible Business Object Instances that may be related with the Business Object Instance.

A task sequence in the UI can be created in the following way. For each of the Aspect Instances that are in a state wherein the Event functionality within their Aspect Pattern cannot react, a task is presented for the user possibly with an indication or a guide of how to bring the Aspect instances in a state where they can react. The order of presenting the Aspect Instances to the user may have been defined in the configuration. For example, a “Service Job” may be configured with an Aspect Type “Identification” of an Identification Aspect Pattern, and an Aspect Type “Technician” of the Relation Aspect Pattern, and the order of Aspect Types should be “Identification” before “Technician”. Thus, for such a configuration, a task sequence of creating a new Business Object Instance of the Business Object Type “Service Job” could be that the user first is presented with a task guiding him/her to create the information of the Aspect Instance defined in the “Identification” Aspect Type (for example choose an identification number) and thereafter presented with a task guiding him/her to create a relation of the Aspect Instance of the “Technician” Aspect Type.

In an embodiment of the invention a task may be created by combining information related with the Event Type and information related with the Business Object Type it is configured with. For example, a task “Start Service Job” presented to the user may be created by use of a “Start” string comprised in the Event Type “Start” and a “Service Job” string of the particular Business Object Type “Service Job” that the Event Type “Start” is configured with.

In an embodiment of the invention a list of possible Event Types that may be fired on a Business Object Type may be obtained and presented to the user. In this way the user is provided with indications of which Event Types that currently can or cannot be reacted upon. One embodiment of the mechanism for doing this is as follows. The BO Component 220 runs through all known Event Types configured with the identified Business Object Types. It asks each of the Aspect Patterns in turn (through their Aspect Interfaces) whether the Aspect Instance is in a state where it can respond to the Event Type. That is, the Event functionality within one or more Aspect Patterns that have been configured with the Event Type reacts to the request and returns whether it is possible to execute the Event Instance or not. The Aspect Pattern Component will respond with either “yes” or “no” depending on the outcome. The Aspect Pattern component can further return a data structure (for example a string) indicating the reason for not being able to respond to the Event Type. In this way a user of the application can be informed whether it is possible, not currently possible, or never will be possible, to fire an Event Instance of the Event Type on the Aspect Pattern.

Also an Aspect Pattern may return a message with information indicating that it does not care about such an Event Type. This may be the case, for example, in situations where the Event Type is not configured with the Aspect Pattern.

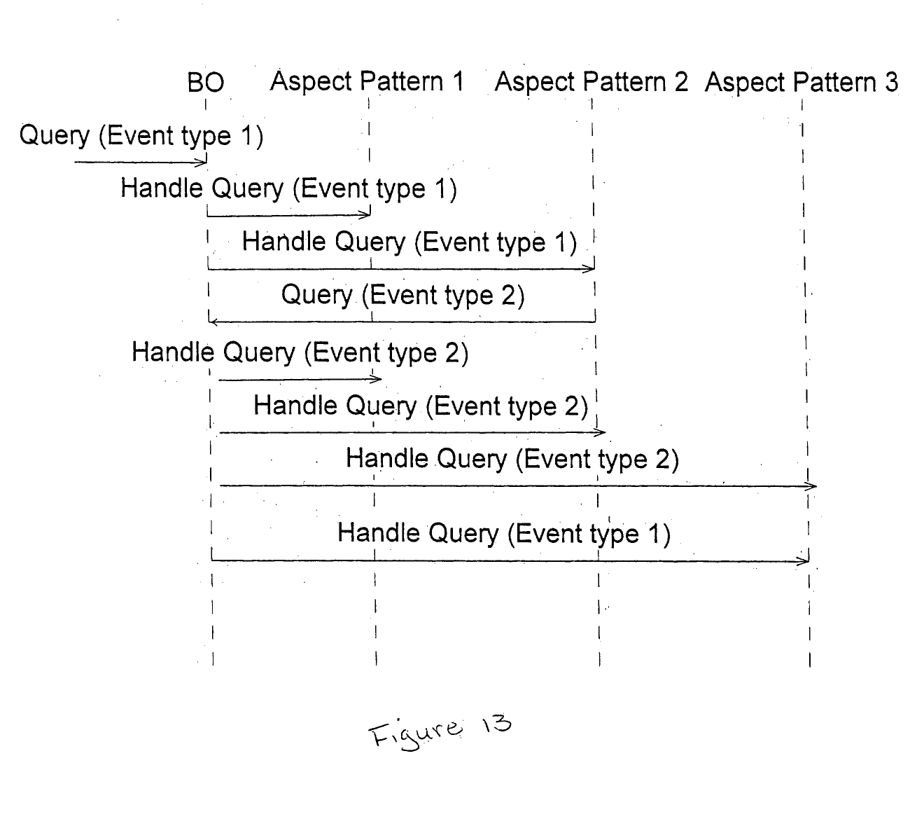

In FIG. 13 a sequence diagram showing a query of an Event Type is illustrated. In the figure a query of the Event Type 1 is initiated by the BO component 220. The Query of the Event Type 1 is then passed on to the Aspect Pattern 1 and Aspect Pattern 2. Aspect Pattern 2 initiates a query of Event Type 2 because it is configured to fire an Event Instance of Event Type 2 in response to Event Type 1. Thereafter the BO component 220 starts passing a query of the Event Type 2 on to all Aspect Patterns, in this case first to Aspect Pattern 1 then to Aspect Pattern 2 and finally to Aspect Pattern 3. The BO component 220 then finishes handling the query of the Event Type 1 by passing the query on to the remaining Aspect Patterns, in this case only to Aspect Pattern 3.

An alternative way of querying about an Event Type can be implemented by using a queue that handles the order in which the querying of Event types is handled. In the above mentioned example this means that the query of the Event Type 2 is postponed until after the query of the Event Type 1 to all Aspect Patterns has been handled.

In an embodiment of the invention the reason that the Aspect Instance is in a state where it cannot react to the Event Type is transmitted to the UI as a task to perform. For instance, it may return a data structure (such as a string) indicating the action it would perform if it were asked to respond to the Event Type. When the Aspect Instance then is in a state where it can react to the Event Type, the Aspect Pattern of the next Aspect Instance is asked whether it can react to the Event Type, and the UI may receive a task to perform if the Aspect Instance was in a state where the Aspect Pattern could not react. Likewise the Aspect Patterns of the remaining Aspect Instances are asked if they can react, and tasks may be returned to the UI in response to the request. In this way a task sequence can automatically be created. In a illustrative embodiment of the invention this can be configured by the “Make possible”/“task sequence” task step in the task pattern “Do Method”.

For example, assume a user of a “Field Service Management” application is responding to a call from a customer that needs to have a piece of equipment repaired. After a new Business Object Instance of Business Object Type “Service Job” has been created and filled in, and the customer confirms that he will pay for the service visit as stated in the Service Job, the user needs to fire an instance of the “Accept” Event Type that has been configured with the “Service Job” Business Object Type. This is accomplished by starting a task “Accept Service Job”. This task queries all the Aspect Instances of the Service Job Business Object Instance, and the Aspect Instance. “Technician”, of Aspect Pattern Relation will not allow an Event Instance of the Event Type “Accept” to be fired, because no technician is assigned to the job. The user therefore modifies the Business Object Instance by picking a technician for the job, and now it is possible to fire an Event Instance of the Event Type “Accept”, which the user does by, for example, pressing a submit button on the screen where the Business Object Instance is presented, which sends a message to the BOC containing the modified Business Object Instance and an identification of the Event Type “Accept”. In response to this message, the BOC will create an Event Instance of the “Accept” Event Type, and actually fire that Event Instance as previously described. Firing the Event Instance corresponds to the “Do” task step in the “Do Method” in a configured Task Pattern.

Although the present invention has been described with reference to particular embodiments, workers skilled in the art will recognize that changes may be made in form and detail without departing from the spirit and scope of the invention.

What is claimed is:

1. A method of developing a computer application to perform tasks, comprising:
providing a set of object types;
providing a set of aspect patterns, the aspect patterns including generalized functionality that can be implemented for at least some of the set of object types; and
establishing desired connections between selected object types in the set of object types and selected aspect patterns in the set of aspect patterns.

2. The method of claim 1 wherein establishing desired connections, comprises:
storing an aspect pattern identifier for a selected aspect pattern in metadata for a selected object type connected to the selected aspect pattern; and
storing an object type identifier for the selected object type in metadata for the selected aspect pattern.

3. The method of claim 2 and further comprising:
providing a set of event types that identify possible occurrences to which aspect patterns and object types can react;
establishing desired connections between selected event types and selected object types; and
establishing desired connections between selected event types and selected aspect patterns.

4. The method of claim 3 wherein establishing desired connections between selected event types and selected object types, comprises:
storing an event type identifier for a selected event type in metadata for a selected object type connected to the selected event type; and
storing an object type identifier for the selected object type in metadata for the selected event type.

5. The method of claim 4 wherein establishing desired connections between selected event types and selected aspect patterns, comprises:
storing an event type identifier for a selected event type in metadata for a selected aspect pattern connected to the selected event type; and
storing an aspect pattern identifier for the selected aspect pattern in metadata for the selected event type.

6. The method of claim 5 wherein establishing desired connections between selected event types and selected aspect patterns, comprises:
identifying selected functionality in the selected aspect pattern that is to be performed in response to the selected event type.

7. The method of claim 5 and further comprising:
providing a set of propagated values; and
establishing desired connections between selected object types and selected propagated values.

8. The method of claim 7 wherein the propagated value includes a source aspect pattern identifier identifying a source aspect pattern from which a new propagated value is received, and a target aspect pattern identifier identifying a target aspect pattern in which the new propagated value is placed.

9. The method of claim 8 wherein establishing desired connections between selected object types and selected propagated values, comprises:
storing an object type identifier for selected object types in metadata for the propagated values.

10. The method of claim 9 and further comprising:
establishing a connection between the source and target aspect patterns and at least one object type.

11. The method of claim 10 and further comprising:
establishing a connection between the source and target aspect patterns and a plurality of different object types.

12. The method of claim 2 wherein the selected aspect pattern comprises a relation aspect pattern, and further comprising:
storing an object type identifier for a second selected object type in metadata for the relation aspect pattern, such that the selected object type and the second selected object type are connected through the relation aspect pattern.

13. The method of claim 1 wherein one of the set of aspect patterns includes a rule expression and a rule source identifier, the rule expression defining a calculation to be performed on at least one specified value and the rule source identifier identifying a location where the specified value is to be retrieved.

14. The method of claim 13 and further comprising:
connecting the one aspect pattern to a second aspect pattern by identifying the second aspect pattern in the rule source identifier of the one aspect pattern.

15. The method of claim 1 wherein providing a set of aspect patterns, comprises:
storing metadata associated with the aspect patterns in a first store; and
storing first order data associated with instances of the aspect patterns in a second store.

16. The method of claim 1 wherein providing a set of object types, comprises:
storing metadata associated with the object types in a first store; and
storing first order data associated with instances of the object types in a second store.

17. The method of claim 3 wherein providing a set of event types, comprises:
storing metadata associated with the event types in a first store; and
storing first order data associated with instances of the event types in a second store.

18. A computer system configured to run an application program, comprising:
a first store storing aspect pattern metadata associated with a plurality of aspect patterns and object type metadata associated with a plurality of object types, the aspect patterns implementing functionality for the object types and the aspect pattern metadata and object type metadata describing connections between the aspect patterns and the object types;
a second store storing aspect pattern instances of the aspect patterns and object instances of the object types;
an object controller controlling interaction between the object instances and the aspect pattern instances based on the aspect pattern metadata and object type metadata.

19. The computer system of claim 18 wherein the first store stores event metadata associated with a plurality of event types and wherein the second store stores event instances of the event types.

20. The computer system of claim 19 wherein the object controller comprises:
an object component configured to receive event instances and provide the event instances to the aspect patterns based on the event metadata.

21. The computer system of claim 20 wherein the object controller further comprises:
an aspect pattern component implementing an aspect pattern interface through which the object component passes event instances to the aspect patterns.

22. The computer system of claim 21 wherein the object controller further comprises:
an event manager component receiving the event instances and managing an order in which the event instances are provided to the object component.

23. The computer system of claim 22 wherein the first data store stores propagated value metadata associated with a plurality of propagated values.

24. The computer system of claim 23 wherein the propagated value metadata identifies a source aspect pattern and a target aspect pattern for each propagated value, the source aspect pattern being an aspect pattern from which the corresponding propagated value is to be retrieved and the target aspect pattern being an aspect pattern to which the propagated value is to be delivered.

25. The computer system of claim 24 wherein the object controller further comprises:
a propagated value component coupled to the object component and identifying target aspect patterns for source aspect patterns provided to the propagated value component from the object component.

26. The computer system of claim 25 wherein the object component is configured to push the propagated value to the target aspect patterns identified by the propagated value component.

27. The computer system of claim 26 wherein the object component is configured to receive from a requesting aspect pattern instance a rule expression indicative of a calculation to be performed on a value, and a source identifying a source aspect instance from which the value is to be retrieved.

28. The computer system of claim 27 wherein the object component is configured to obtain the value from the source aspect instance and perform the calculation using the value to obtain a new value.

29. The computer system of claim 28 wherein the object component is configured to return the new value to the requesting aspect pattern instance.
